(19) United States
(12) Patent Application Publication
(10) Pub. No.: US 2026/0174262 A1
(43) Pub. Date: Jun. 25, 2026

(54) DOOR WITH BUILT IN COLLAPSIBLE SAFE BOX

(71) Applicant: Eco Earth Holdings, Inc., Carlsbad, CA (US)

(72) Inventor: Anthony Chiappetta, San Diego, CA (US)

(21) Appl. No.: 19/532,487

(22) Filed: Feb. 6, 2026

Related U.S. Application Data
(63) Continuation of application No. PCT/US2024/012592, filed on Jan. 23, 2024.
(60) Provisional application No. 63/531,493, filed on Aug. 8, 2023.

(51) Int. Cl. A47G 29/28; A47G 29/14

(52) U.S. Cl. CPC A47G 29/28; A47G 29/141

(57) ABSTRACT

A door having a collapsible safe box that can be deployed to receive an item or package and automatically transfer it to inside a room. The collapsible safe box may include protractible and retractable side member, bottom member, and lid. The collapsible safe box may include one or more electronic devices to monitor and operate the functioning of the safe box. In examples, the door may include an opening at a rear portion of the collapsible safe box and a door hatch for opening and closing the opening as the collapsible safe box is retracted and protracted.

### FIELD OF THE INVENTION

The present invention relates to a door with built in collapsible safe box.

### BACKGROUND OF THE INVENTION

Package delivery to residential and business premises is a ubiquitous practice. While carriers and delivery agencies can take the appropriate precautions that a package is safely transported to its destination, the safety of the package becomes compromised once it is left unattended at the receiving party's premises or business. Left unattended, the package can often be the target of theft or destruction.

To address this problem a series of delivery receptacles have been devised that can safely secure the package between the time it is delivered and the time the recipient is able to take physical possession of the package. Exemplary systems to safely keep delivered packages are described in U.S. Pat. No. 10,143,321, US Patent Publication Nos. 20160051073, 20170091710, 20170127868, 20180029760, International Publication No. WO2019217232, and Chinese Patent Publications No. CN103291172, CN202544628, and CN203420569. All these documents are incorporated herein by reference in their entirety.

While the above identified publications may provide for secured receptacles for a variety of different objects, they may not provide the safety of having a delivered object inside the premises or business and also often require either a permanent bulky secured structure and/or permanent installation on the grounds or wall of the premises or business. For these reasons, the disclosed devices are not conducive for situations where a permanent structure is either not allowed or where a permanent bulky structure is inconvenient.

Accordingly, there is a need for a delivery structure that can be easily removably installed and/or collapsible to yet provide a safe receptacle for deliveries that does not involve a bulky structure to always be present.

### SUMMARY OF THE INVENTION

Examples of a door including a collapsible safe box can substantially obviates one or more of the problems due to limitations and disadvantages of the related art.

Examples can provide a door including a collapsible safe box that can be securely yet removably installed.

Examples can provide a door including a collapsible safe box that can be expanded and securely accessed to store a package.

Examples can provide a door with a built in collapsible and expandable safe box. In examples, the door may include a custom commercial steel grade door. In examples, the door may be configured to receive and secure multiple parcels/packages per day from theft, damage, and the elements when delivered to businesses and or any build structure with a door opening. In examples, the door can replace an existing door by removing only the pins on hinges and reinstall or install to any new standard door frame opening by installing new hinges. In examples, the door design may secure multiple delivered packages by allowing the access for the packages only to be placed inside the secured structure of a business or other building structure.

In examples, upon delivery of an item, parcel and/or package, the access to the safe box that is part of the door may be obtained by a deliverer by submitting a code or by a drone by way of a transmitter. In examples, the safe box may automatically extend to its opened position. In examples, opening of the safe box may cause activation of one or more cameras on the door and/or inside safe box. The one or more cameras may be configured to record and optionally confirm safe delivery of the item, parcel, or package. In examples, once the lid of the safe box is closed, the box may automatically retract to its collapsible position while simultaneously opening an interior access panel allowing for the delivered item, package or parcel to pass through the access opening and be transferred into the building structure. In examples, once the lid of the safe box is closed, an interior access panel may be opened and then the safe box may automatically retract to its collapsible position allowing for the delivered item, package, or parcel to pass through the access opening and be transferred into the building structure. In examples, the safe box may be configured to reset in its collapsible position for the next use after the item, package, or parcel has been transitioned inside the building structure. In examples, use of a door as described can avoid the need for requiring a signature upon delivery as it may act as authentication of delivery address by communicating same with the third party deliverer.

In examples, a software application may be employed to notify a recipient of the delivery of said item, parcel, or package amongst other functions.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, a door having a collapsible safe box; an opening in communication with an internal portion of the safe box; and a door hatch configured to close the opening when the safe box is deployed. In examples, the collapsible safe box may include a protractible and retractable side member, a protractible and retractable lid, and a protractible and retractable bottom member.

The collapsible safe box may include at least two protractible and retractable side members. The collapsible safe box may include a front panel. In examples, the protractible and retractable lid may be configured to engage the front panel. In examples, the protractible and retractable lid may include a lid smart lock. The protractible and retractable lid may include two or more stackable panels. In examples, the collapsible safe box may include a lid housing configured to store at least a portion of the protractible and retractable lid in a stowed state.

In examples, the door may include a front side and an opposite back side, wherein the lid housing is on a back side of the door and at least a portion of the protractible and retractable lid is on a front side of the door when protracted.

The collapsible safe box may include a telescoping arm operably connected to at least one of the at least two protractible and retractable side members.

The collapsible safe box may include a roller configured to wind and unwind the protractible and retractable bottom member. In examples, the door may include a motor operably connected to the roller. In examples, the door may include a reel or clog operably connected to the door hatch and operably connected to the motor, the roller, or both.

In examples, the collapsible safe box may include a back frame located on a back side of the door; and a ramp pivotally connected to the back frame.

In examples, the collapsible safe box may include a camera. The camera may be arranged to capture the environment outside the collapsible safe box. The camera may be arranged to capture the environment inside the collapsible safe box. In examples, a camera may also be arranged so that in may be inside the safe box when the safe box is deployed and outside the safe box when the safe box is in a stowed stated. In this manner, a camera may capture the inside of the safe box when the safe box is deployed and the inside of a room when the safe box is in a stowed state.

In examples, collapsible safe box may include one or more sensors. The one or more sensors may be arranged to detect whether the safe box is secured.

In examples, the collapsible safe box may include an alarm.

In examples, the collapsible safe box may include a sterilizer. In examples, the sterilizer

may be located inside the safety box. The sterilizer may include a UV light emitter.

In examples, the collapsible safe box may include a scanner.

In examples, the door may include a power source. In examples, the power source may

include a battery. In examples the battery is a rechargeable battery. In examples, the door may include an electricity generator. In examples, the electricity generator may be a solar panel.

In examples, the door may include a door lock. The door lock may be a smart lock.

In examples, the door may include a display. The display may include a touch screen.

In examples, the door may include an antenna.

In examples, the door may include a light fixture.

In examples, the door may include a controller.

In examples, the door may include a motor.

In examples, the door may include a reel or clog operably connected to the door hatch via one or more cables. In examples, the reel or clog may be operably connected to a motor. In examples, the reel or clog may be configured to cause the door hatch to close the opening when the safe box is deployed and to open the opening when the safe box is stowed.

Also provided is a door for delivery including an antenna for wireless communication, a controller, a collapsible safe box, an opening located at a rear portion of the collapsible safe box, a door hatch configured to close the opening when the safe box is deployed. In examples, the antenna may be used for communicating with a drone.

Also provided is a method of receiving a delivery including receiving at a door an input signal to deploy a safe box; expand a safe box, wherein the safe box is an integral portion of the door; causing a door hatch to block of an opening extending from a front side of the door to a back side of the door, the opening located at a rear portion of the safe box when the safe box is expanded; receiving an item in the safe box; locking the safe box; cause the door hatch to free the opening; retract a safe box cause the item to pass through the opening.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate examples of the invention and together with the description serve to explain the principles of the invention.

In the drawings:

FIG. 1 illustrates an example of front view of a door with a collapsible safe box.

FIG. 2 illustrates an example of rear view of a door with a collapsible safe box.

FIG. 3 illustrates an example of rear view of a door with a collapsible safe box illustrating opening behind the safe box providing access to an inside area of the safe box.

FIG. 4 illustrates an example of left side view of a door with a collapsible safe box in a stowed state and a deployed ramp.

FIG. 5 illustrates an example of left side view of a door with a collapsible safe box in a deployed state and a deployed ramp.

FIG. 6 illustrates an example of top-down view of a door with a collapsible safe box in a stowed position and a deployed ramp.

FIG. 7 illustrates an example of top down view of a door with a collapsible safe box in a deployed state and a deployed ramp.

FIG. 8A is a bottom view of the safe box lid.

FIG. 8B is a top-down view of the front panel or facia.

FIG. 9 is a diagram view of a control system that may be used in the present invention.

FIG. 10 illustrates an example process flow diagram of door and safe box to receive delivery of an item, package, or parcel.

FIG. 11 illustrates an example process flow diagram of door and safe box to secure an item, package, or parcel for pickup and delivery.

### DETAILED DESCRIPTION OF THE ILLUSTRATED EXAMPLES

Reference will now be made in detail to an example of the present invention, example of which is illustrated in the accompanying drawings.

Unless defined otherwise, all technical and scientific terms used herein have the same meaning as is commonly understood by one of skill in the art to which the inventions belong. All patents, patent applications, published applications and publications, websites and other published materials referred to throughout the entire disclosure herein, unless noted otherwise, are incorporated by reference in their entirety. In the event that there are a plurality of definitions for terms herein, those in this section prevail. Where reference is made to a URL or other such identifier or address, it is understood that such identifiers can change and particular information on the internet can come and go, but equivalent information can be found by searching the internet. Reference thereto evidences the availability and public dissemination of such information.

As used herein, the singular forms “a,” “an” and “the” include plural referents unless the context clearly dictates otherwise.

As used herein, the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example examples.

As used herein, ranges and quantities can be expressed as “about” a particular value or range. “About” also includes the exact amount. Hence “about 5 percent” means “about 5 percent” and also “5 percent.” “About” means within typical experimental error for the application or purpose intended.

As used herein, “optional” or “optionally” means that the subsequently described event or circumstance does or does not occur, and that the description includes instances where the event or circumstance occurs and instances where it does not. For example, an optional component in a system means that the component may be present or may not be present in the system.

As used herein, a “combination” refers to any association between two items or among more than two items. The association can be spatial or refer to the use of the two or more items for a common purpose.

As used herein, “comprising” and “including” are meant to be inclusive of other elements or parts unless otherwise specifically described. Thus, for example, if an element or feature is described as being included or comprised, it does not mean that other elements or features are excluded, but that other elements or features can also be further be present.

In examples, a door having an integrated a collapsible safe box may be provided for securing items such as parcels/packages from theft and potential damage from the elements when delivered to homes/businesses. The door may be equipped with its own electricity generator such as a solar panel, and its own energy storage such a battery. The door may be equipped with a controller for operation of one or more components of the door and/or for communication and/or interaction with an external entity. In examples, the door may include one or more antennas to aid in wireless communication. The door may also be equipped with one or more displays to display an image or message. In examples, the display may include a touch screen and operate as a user input device.

In examples, door may also include an opening at a rear portion of the safe box. The opening may provide access to the internal area of the safe box. The opening may extend through the thickness of the door. In examples, the door may also include a door hatch configured to block and unblock or open and close the opening located at the rear of the safe box. In examples, the operation of the door hatch may be coordinated with the expansion and contraction of the collapsible safe box.

In examples, the safe box may be used to receive or return an item, package, or parcel. In examples, a deliverer may place an item, package, or parcel in the safe box upon delivery. In examples, a user may place an item, package, or parcel. in the safe box for pickup by a delivery person. In examples, one or more parcels or packages may be placed in the safe box for safe keeping upon delivery or in anticipation of pickup by a delivery service. In examples, safe box may be activated and expanded prior to placing an item, package, or parcel therein. In examples, once the item, package, or parcel is placed in the safe box, a lid of the safe box may be closed and locked to secure the contents of the safe box. In examples, the safe box can include one or more sensors able to activate one or more hidden cameras to record and confirm the one or more parcels or packages were safely placed in the safe box.

A software application can be used to notify the recipient (for example, live time) the receipt of the one or more parcels or packages.

If an item is being received at the delivery door, once the item, package, or parcel is locked inside the safe box, the safe box may be configured to return to its collapsed or stowed state either after the door hatch has opened the opening behind the safe box or while causing the door hatch to open the opening behind the safe box. As the safe box collapses, it may cause the item, package, or parcel contained therein to pass through the opening and transit to the room on the back side of the door.

If an item, package, or parcel is placed in the safe box for pick up, during and until the delivery pick-up retrieves said one or more parcels or packages from the safe box, the items, parcels or packages can remain securely locked avoiding any convenient theft. In this manner the safe box may deter any attempts to steal the delivered items. In examples, the safe box may be equipped with an alarm that may set off if there is an attempt to temper with the safe box.

In examples, the safe box can be locked using a traditional lock, a smart lock or any combination thereof. Any suitable locking mechanism may be employed to achieve a secure engagement of a lid with a front panel, one or more side members, or any combination thereof. In examples, the locking mechanism may include clamps, hooks, screws, hole and pin systems, male-female fittings configured to engage when coupled, gears, magnets, electromagnets, or any combination thereof. Although discussed in the singular form for easy of discussion, in examples, two or more locking mechanisms may be employed. In examples, the lock may include a touch screen or keypad. The lock can include a night light. The safe box can include one or more hidden cameras and sensors. The safe box can optionally include a GPS tracker.

Activation or opening of the safe box may be effectuated by performing one and or more access functions. In examples, the steps required to retrieve the contents from a safe box may be set according to the preferences of a user. In examples, access to the inside of a locked safe box may include one or more of a security code, symbol scanner such as QR code, bar code, or similar symbology, finger scan, iris scan, voice recognition, physical or electronic key, any combination thereof, or any other like manner. In examples, access to the safe box may require a 4 to 5 digit code on a touch screen or key pad. For example, a scanner may be provided to allow for scanning a fingerprint, iris, symbology, or other scannable item. In examples, activation and/or access of the safe box may be caused by wireless transmission. Other means to unlock the safe box and access the package can also be available as described in more detail below.

In examples, as also described in more detail below, the safe box may be equipped with one or more sensors that are able to detect when an item such as a parcel or package is placed inside the safe box. In examples, in response to detecting an item placed in the safe box, one or more UV lights can be activated. For example, one or more sensors can be triggered by the item or package touching a portion of the bottom of the safe box. In examples, the sensor can be an optical sensor and be triggered by visual appearance of the item or package. Other alternatives are also available. In examples, one or more sensors can send a signal to a controller, a UV light controller, a switch, or any combination thereof. In examples, one or more UV light emitters can be triggered by a signal from the one or more sensors, from a controller, from a switch, or any combination thereof. In examples, one or more UV light emitters can be set on a self-timer within the safe box. The UV light emitter can be configured to irradiate the contents of a safe box. In examples, UV light can be used for disinfecting the items or deposited parcels or packages placed inside the safe box.

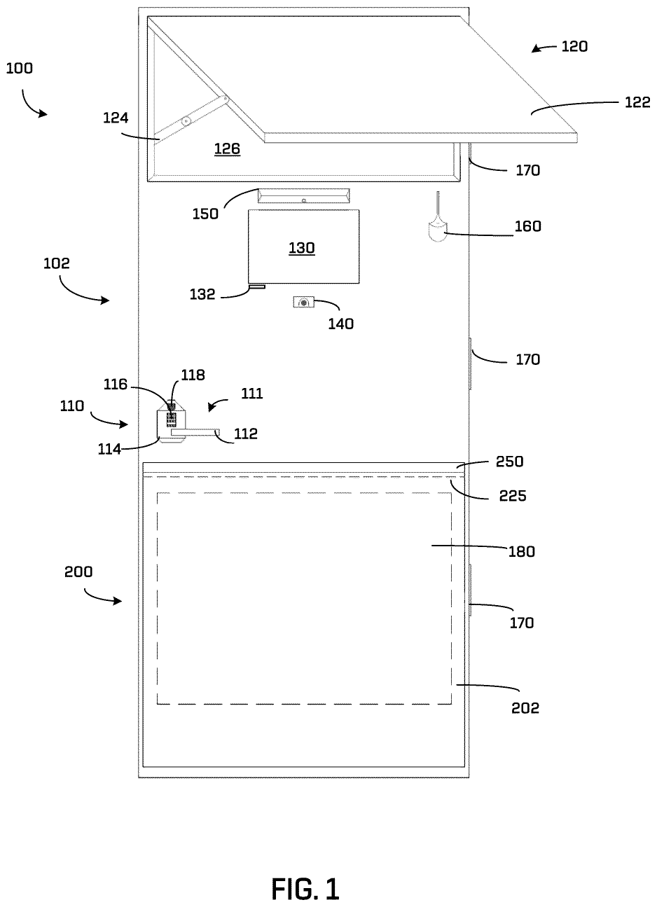

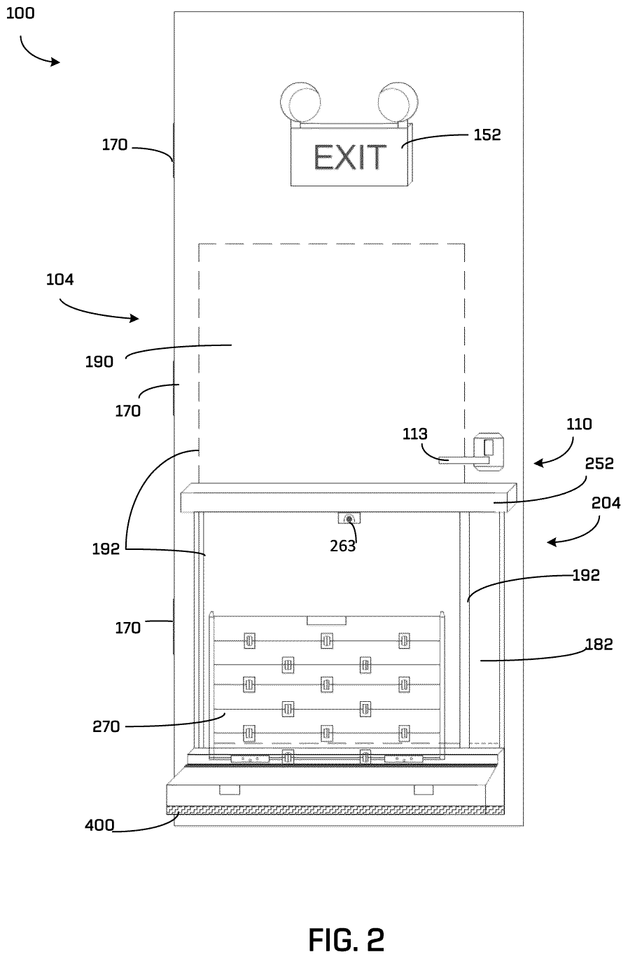

FIG. 1 illustrates an example front view of a delivery door 100 with a safe box 200. Safe box 200 as described herein may be a collapsible safe box. As shown in FIG. 1, delivery door 100 may include a collapsible safe box 200. The term collapsible with respect to safe box 200 is used herein to indicate that safe box 200 may be expanded or protracted into a deployed state, and compressed or retracted into a stowed state as described herein. The collapsible safe box 200 may be an integral portion of door 100. Door 100 may include a front side 102 and a back side 104. For purposes of this description, a door front side 102 refers to the portion of door 100 that, when installed, faces outside of the room or building to which door 100 blocks access when closed. Likewise, for purposes of this description, a door back side 104 (illustrated in FIG. 2 showing a rear view of door 100) refers to the portion of door 100 that, when installed, faces inside of the room or building to which door 100 blocks access when closed.

In examples, door 100 may have a standard door size. In examples, door 100 may have a width of 36 inches, a length of 84 inches, and a depth of 1.75 inches. Other sizes may also be used depending on the doorway on which door 100 is to be installed.

In examples, door 100 any include any suitable material typically used for a door. In examples, door 100 may include a material used for industrial type doors. In examples, door 100 may include a polymer, a metal, or any combination thereof. For example, door 100 may include steel. In examples, door 100 may include powder coated steel, hemp steel flex or any combination thereof. In examples, door 100 may include aluminum. In examples door 100 may include galvanized metal, such as galvanized steel and/or iron. In examples, door 100 may include on or more of polyvinyl chloride (PVC), polystyrene, polyurethane, or any combination thereof. In examples, door 100 may include fiberglass. In examples, door 100 may include graphite carbon. In examples, door 100 may include a mixture of steel and one or more of fiberglass, graphite carbon, galvanized metal, aluminum or other metal, PVC, polystyrene, and polyurethane. In examples, door 100 may include a metal outer shell and polymer or metal material filler. In examples, door 100 may be a hollow door. In examples, door 100 is partially filled and partially hollow.

Door 100 may include a door lock 110. Door lock 110 may be configured to cause door 100 to lock and unlock. In examples, door lock 110 may be configured to cause door 100 to lock and/or unlock based on an electronic input. In examples, door lock 110 may include a handle portion 111. Handle portion 111 may include one or more handles 112 and 113. In examples, one handle 112 may be provided on the door front side 102 and one handle 113 may be provided on the door back side 104. Handles 112 and 113 be any suitable shape that can be gripped by a hand to open and/or close door 100. In examples, door lock 110 may be operated using a key. In examples, door lock 110 may include a smart lock 114. In examples, a door smart lock 114 may include one or more locks and a management system. The one or more locks may be operated by one or more keys and/or electronically. In examples, door smart lock 114 may be opened and closed using a standard key. In examples, door smart lock 114 may be opened and closed using an electronic key, such as a fob or key fob and/or a keycard. In examples, a keycard can include a holecard, barcode, magnetic stripe, Wiegand embedded cards, a smart card embedded with a read-write electronic microchip, and RFID proximity card. In examples, door handle 110 may include a door smart lock 114 having one or more input components. In examples, a smart lock 114 may include a door lock keypad 116. In examples, a door smart lock 114 may include a door lock scanner 118. Scanner 118 may be a fingerprint scanner, a facial scanner, an iris scanner, or any combination thereof. In examples, door smart lock 114 may be configured to be operated by remote device such as a smart phone or remote control. In examples, for remote operation, door smart lock 114 may include a transceiver. Wireless communication can be performed via wireless network, radio frequency, Bluetooth connection, or any like network. In examples, door smart lock 114 may be operated via controller 300. In examples, wireless communication to door smart lock 114 may be conducted using antenna 160.

In examples, door 100 may include one or more electricity generators 120. In examples, an electricity generator 120 may be a solar panel. In examples, an electricity generator may be a thermoelectric generator, a wind powered generator or any like device. For illustrative purposes only, the electricity generator 120 will be described as a solar panel. As illustrated in FIG. 1, in examples, an electricity generator 120 may be provided on a front side 102 of door 100. In examples, an electricity generator 120 may be provided on a back side 104 of door 100. In examples, a first electricity generator may be provided on the front side 102 and a second electricity generator may be provided on the back side 104 of door 100.

In examples, an electricity generator 120 may include one or more panels 122. In examples, a panel 122 may be connected to door 100 by at least one or more articulated arms 124. In examples, using an articulated arm 124 the positioning of panel 122 may be adjusted. In examples, door 100 may include a recess 126 on its surface to fit panel 122 of the electricity generator 120. Illustrated in FIG. 1, a door 100 may include an electricity generator 120 such as a solar panel having a panel 122 connected to door 100 at least by one or more articulated arms 124, and a recess 126 in which panel 122 of the solar panel 120 can fit. In examples, the electricity generator 120 may be electrically coupled to an energy storage 400 described later. In examples, the electrical coupling or connection between the electricity generator 120 and the energy storage may be made via one or more electrical wires or other electrically conductive structure.

In examples, door 100 may include a display 130. In examples, display 130 may be any flat panel display. In examples, display 130 may include a liquid crystal display (LCD), light emitting device (LED) display, a plasma display, or any like devices. In examples, display 130 may include a touchscreen configured to receive inputs. In examples, display 130 may be configured to also act as a user interface to access and send commands to controller 300 and/or to any components of door 100 and/or safe box 200. In examples, display 130 may include a display input controller 132. In examples, controller 132 may be in addition to the display having a touchscreen. Input controller may be a remote controller or may be provided as a portion of the display 130. In examples, display 130 may include a processor, memory, and logic as generally available in a display screen, smart TV, or other display device. In examples, display 130 may be controlled via controller 300. In examples, display 130 may be configured to display any desired message and/or image. In examples, one or more displays 130 provided on door 100 may be powered by an energy storage 400, a separate power source, or a combination of both.

In examples, display 130 may be provided on any portion of door 100. In examples, one or more displays 130 may be provide on a front side 102 of door 100. In examples, one or more displays 130 may be provided on a back side 104 of door 100. In examples, at least a first display may be provided on a front side 102 of door 100, and at least a second display may be provided on a back side 104 of door 100. In examples, a display 130 may be provided on a front portion of safe box 200. In examples, a display 130 may be provided on a portion of door 100 where safe box 200 is not located, as for example illustrated in FIG. 1.

In examples, door 100 may include one or more door optical sensors 140. In examples, an optical sensor may include a video capturing device. In examples, an optical sensor may include a camera. A camera may be a video camera, and infrared camera, or both. In examples, door 100 may have two or more cameras. In examples, door 100 may include one or more optical sensors on a front side 102. In examples, door 100 may include one or more optical sensors on a back side 104. In examples, door 100 may include one or more optical sensors on a front side 102 and one or more optical sensors on a back side 104. In examples, one or more optical sensors 140 provided on door 100 may be powered by an energy storage 400, a separate power source, or a combination of both.

In examples, door 100 may include one or more light fixtures 150. Illustrated in FIG. 1, in examples, door 100 may include one light fixture 150. In examples, light fixture 150 may include a motion sensor and activate at night and/or in the dark when motion is detected. In examples, activation of light fixture 150 may be controlled by controller 300. In examples, controller 300 may activate light fixture 150 based on a sensed motion from one or more optical sensors 140, and/or from a sensed activation or operation of safe box 200 and/or of lock 110. In examples, door 100 may include two or more light fixtures 150. In examples, door 100 may include one or more light fixtures on a front side 102. In examples, door 100 may include one or more light fixtures on a back side 104. In examples, door 100 may include one or more light fixtures on a front side and one or more light fixtures on a back side. In examples, a light fixture 150 may include any type of light emitting device. In examples, light fixture 150 may include one or more light emitting diodes (LED), one or more light bulbs, one or more neon lights, one or more halogen incandescent lights, one or more fluorescent lamps (CFLs), or any combination thereof. In examples, one or more light fixtures 150 provided on door 100 may be powered by an energy storage 400, a separate power source, or a combination of both.

In examples, door 100 may include one or more antennas 160. One or more antennas 160 may be located on the front side 102 and/or back side 104 of door 100. Illustrated in FIG. 1, door 100 includes at least one antenna 160 on the front side 102. In examples, an antenna 160 may be operably connected to one or more components of door 100. In examples, antenna 160 can include a transceiver. In examples, antenna 160 can be configured to receive, send, or send and receive signals. In examples, antenna 160 may assist or provide a means for wireless communication between one or more components of door 100 and a remote party. In examples, one or more antenna 160 can be operably connected to and provide a means for sending and/or receiving wireless communication for smart lock 114, one or more electricity generators 120, one or more displays 130, one or more optical sensors 140, one or more light fixtures 150, safe box 200 or any of its components, controller 300, or any combination thereof. In examples, an antenna 160 may be configured to operate with any wireless means such as for example wi-fi, blue tooth, RF signals via wireless network such as wi-fi and wireless local area network (WLAN), radio frequency, blue tooth connection, or any like network. In examples, one or more antennas 160 provided on door 100 may be powered by an energy storage 400, a separate power source, or a combination of both.

In examples, antenna 160 may be configured to allow communication between the controller 300 of door 100 and a drone or other third party. In examples, a delivery drone may communicate with controller 300 via antenna 160 so that safe box 200 may be activated and deployed for the delivery drone to deposit an item, parcel, or package therein. In examples, the drone may itself enter safe box 200 and remain in safe box 200. In examples, the drone may simply deposit the item, parcel, or package and leave. Safe box 200 may then automatically close to secure its contents. In examples, as described below, safe box 200 may optionally expose the contents to a sterilization process. In examples, as also described below, safe box 200 may ultimately retract into a stowed position delivering its contents to inside the room or building from which door 100 blocks access when closed.

In examples, door 100 may include additional features 152. In examples, as illustrated in FIG. 2, door 100 may include a feature 152 such as an emergency exit sign. In examples, an additional feature 152 may be an illuminated sign. In examples, additional feature 152 may include other types of illuminated or non-illuminated signs. In examples, additional features 152 may include electronic and non-electronic devices. In examples, one or more additional features 152, if electronic devices, provided on door 100 may be powered by an energy storage 400, a separate power source, or a combination of both.

In examples, door 100 may be configured to be installed at a doorway using one or more hinges 170. In examples, hinges 170 can be standard door hinges. In examples, hinges 170 may include metal such as steel. In examples, as illustrated in FIG. 1, door 100 may include three hinges 170. In examples, door 100 may include more or fewer than three hinges. In examples, a hinge 170 may be engaged to a hinge on a doorway via one or more pins.

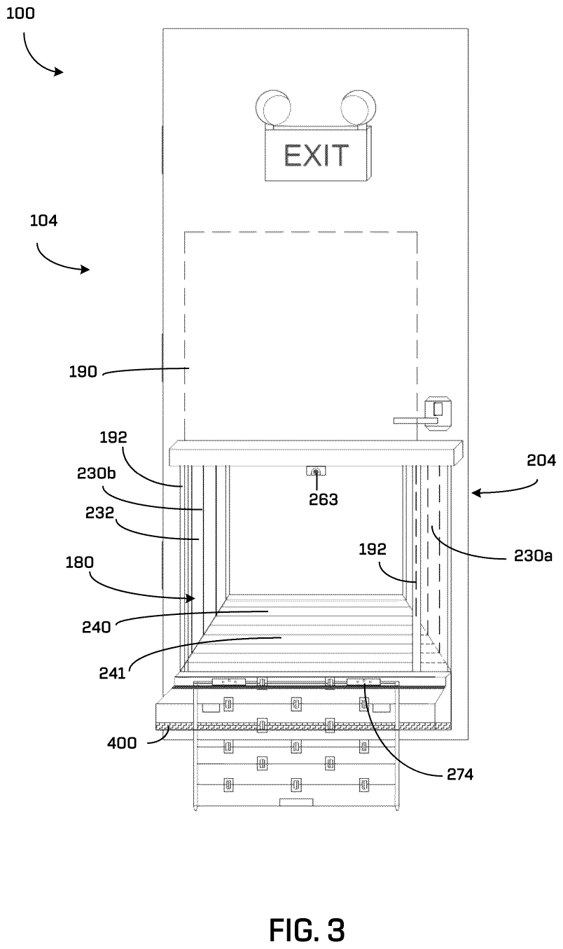

In examples, as shown in FIG. 3, a rear view of door 100, door 100 may include an opening 180 at a location corresponding to where safe box 200 may be located. In examples, opening 180 is located at a rear portion of safe box 200. In examples, opening 180 extends through the thickness of door 100. In examples, opening 180 extends from front side 102 of door 100 to back side 104 of door 100. In examples, opening 180 allows transit into and out of the internal volume of safe box 200. In examples, opening 180 may be in communication with an internal portion and/or internal area or volume of safe box 200.

In examples, opening 180 can have the same dimensions as the inner cross-section of a volume of safe box 200. In examples, opening 180 may have the same or different width and height as safe box 200 and/or of the internal volume of an expanded safe box 200. In examples, opening 180 is smaller than the cross-section of safe box 200 inner space. In examples, as illustrated in FIG. 2, door 100 may include a filler 182 section to compensate for an opening 180 that is smaller than a cross section of safe box 200. In examples, filler 182 may be of the same material as door 100. In examples, opening 180 may be configured to allow items, parcels, and/or packages deposited in safe box 200 to pass through door 100 and reach the room or building from which door 100 is configured to block access when closed.

In examples, door 100 may include a door hatch 190 configured to open and close opening 180. In examples, door hatch 190 may include a sheet of material. In examples, door hatch 190 can include a gate like structure with two or more spaced openings. In examples, door hatch 190 can include combination of sheet of material and gate like structure. In examples, door hatch 190 may include metal, plastic, glass, polymer, natural fiber, wood, or any combination thereof. In examples, door hatch 190 can be located inside door 100. In examples, door hatch 190 may be located on the front side 102 or back side 104 of door 100. FIGS. 2-7 illustrate door hatch 190 in broken lines to indicate that in the examples illustrated it is located inside door 100.

Door hatch 190 can have any desired shape and size. In examples, door hatch 190 can have a shape that is multilateral, for example quadrilateral or triangular, curved, circular, oval, semi-circular, and can have regular or irregular, or any combination thereof. In examples, door hatch 190 can be sized and shaped to fully open and close opening 180. In examples, door hatch 190 may be a single integral body. In examples, door hatch 190 can be a combination of two or more members. In examples, door hatch 190 can include two or more members that operate cooperatively to open and close opening 180. In examples, door hatch 190 or any portion thereof can be configured to slide vertically inside door 100. In examples, door hatch 190 or any portion thereof can be configured to slide horizontally, rotationally, and/or diagonally inside door 100.

In examples, door hatch 190 can be configured to move along one or more tracks or channels, such as C-channels. In examples, operated via one or more cables, gears, balls, pulleys, or any combination thereof. In examples, door 100 may include a motor 248 to cause door hatch 190 to open and/or close opening 180.

As illustrated in FIGS. 1-5, in examples, door hatch 190 may include a quadrilateral, metal sheet configured to slide vertically from an upper inner portion of door 100 to a lower portion of door 100 where opening 180 is located. In the illustrated example, door hatch 190 may be configured to slide along a track or C-channel 192 provided on one or both sides of door hatch 190. Also, as illustrated, door 100 may include one or more cables 194 operably connected to door hatch 190 to lift and lower door hatch 190. In examples, the one or more cables 194 may be operated using one or more balls or pulley system 196 that may be provide inside door 100. In examples, motor 248 may be operably connected to a reel or clog 198 either directly or indirectly. In examples, one or more belts or chains 199 may be used to operably engage reel or clog 198. In examples, reel or clog 198 may be operably connected to one or more cables 194, thus exerting a pull or release on one or more cables 194 when it rotates. In examples, reel or clog 198 by be operated by its own independent motor, similar to motor 248.

In examples, motor 248 may be any suitable motor. In examples, motor 248 may be an electric motor. In examples, motor 248 may be an electric clutch motor. In examples, motor 248 may be an electric clutch motor and clog. Other types of motors may also be employed. In examples, motor 248 may be powered by power source 400. In examples, motor 248 may include a 12 v/24 v transformer.

In examples, as discussed in more detail later, the operation of door hatch 190 may be coordinated with the expansion and retraction of safe box 200.

In examples, such as shown in FIGS. 1 to 7, delivery door 100 may include a safe box 200. Safe box 200 may be a collapsible safe box. Safe box 200 may be an integral portion of door 100. In examples, safe box 200 may be deployed from a collapsed state to an extended state when an item, parcel, or package is to be placed inside. In examples, safe box 200 may be used to receive items being delivered and/or to hold items to be picked up for delivery.

It should be understood that many of the described operations of safe box 200 as described may be similar for items being received and for items being placed in safe box 200 for pickup. In examples, for both receipt of an item, package, or parcel, and for pickup of an item, package, or parcel, safe box 200 may provide a secured location to hold the contents. In examples, as described, when an item, package, or parcel is being received, safe box 200 may automatically collapse and transition the item, package, or parcel inside the room or building from which door 100 blocks access when closed. When an item, package, or parcel is to be retrieved from a locked safe box 200, it may be accessed by unlocking safe box 200 either manually using the lid lock of safe box 200, or via wireless communication as described.

As illustrated in FIGS. 1 to 7, a safe box 200 can include a front frame 202 on a front side 102 of door 100 and a back frame 204 on back side 104 of door 100. Frames 202 and 204 may independently define any desirable shape. In examples, frame 202 and 204 each independently may define a multilateral shape such as a quadrilateral or triangular shape. In examples, frame 202 and 204 each independently may define a circular, curved, semi-circular, or oval shape. In examples, frame 202 and 204 may independently define a regular or irregular shape. In examples, the shape defined by front frame 202 corresponds to the shape defined by back frame 204.

In examples, frames 202 and 204 are integral portions to door 100 or are connected to door 100. Any suitable means for connecting frames 202 and 204 to door 100 may be used. In examples, the connections may be made using one or more fasteners. Fasteners can include screws, bolts, brackets, pins, adhesives, and any combination thereof as well as any similar mechanism. In examples, front frame 202 and back frame 204 may be connected to each other with a portion of door 100 between them. For examples, one or more fasteners such a bolt or fitting may reach from front frame 202 to back frame 204. In examples, front frame 202 and/or back frame 204 may be welded to door 100.

In examples, frames 202 and 204 may define opening 180 in door 100. In examples, opening 180 may be smaller than an area defined by frames 202 and/or 204. In examples, only one of frames 202 and 204 defines opening 180. In examples, a filler 182 may be included along with opening 180 in the area defined by front frame 202, back frame 204, or both as illustrated in FIG. 2.

In examples, one or more tracks or channels 192 may extend along at least a portion of front frame 202, back frame 204, or both. In examples, one or more tracks or channels 192 are not part of front frame 202 or back frame 204. In examples, where filler 182 is used, a track or channel 192 may be located along at least an edge of the filler 182 as shown in FIG. 2.

In examples, front frame 202 and back frame 204 may be made of any suitable material. In examples, frames 202 and 204 may be made of the same or different material. In examples, frames 202 and 204 may be made of the same or similar material described for door 100. In examples, frames 202 and 204 each may independently include a metal, plastic, polymer, wood, fiberglass, or any combination thereof. In examples, frames 202 and 204 both include metal. In examples, frames 202 and 204 both include steel.

In examples, front frame 202 may include one or more borders 210. In examples, borders 210 may extend from door 100 (i.e. have a width) of between one inch and twenty inches. In examples, the width of a border 210 may be one inch or greater and be equal to or less than 20 inches, 15 inches, 10 inches, 9 inches, 7 inches, 7 inches, 6 inches, 5 inches, 4, inches, 3 inches, or 2 inches. In examples, a border 210 may extend along a side of front frame 202. In examples, a border 210 may extend along both sides of front frame 202. In examples, a border 210 may extend along a bottom portion of front frame 202. In examples, border 210 may extend along both sides and along a bottom portion of front frame 202. In examples, border 210 may be formed of the same material as described for front frame 202, door 100, or any panel structure described herein.

In examples, safe box 200 may include a front panel or facia 220 at least one side member 230, a bottom member 240, and a lid 250. In examples, the at least one side member 230 is a protractible and retractable side member 230. In examples, lid 250 is a protractible and retractable lid 250. In examples, the bottom member 240 is a protractible and retractable bottom member 240. In examples, the collapsible safe box 200 includes two side members 230. In examples, the two side members 230 are two protractible and retractable side members 230.

For purposes of this disclosure, the terms “protract” and “protractible” are used to indicate an ability to extend forward or outward, increase in length, and/or extend from a first location to a second location. In examples, any extension means can be employed. In examples, extension may include unfolding, lengthening, flattening, stretching, decompressing, opening, spreading, pulling, telescoping, sliding, unrolling, unwinding, moving from a stored position to an unstored position, or any like movement and any combination thereof.

For purposes of this disclosure, the terms “retract” and “retractable” are used to indicate an ability to withdraw, draw back, shorten in length, and/or to recede or retreat from a second location to a first location. For purposes of this description, retract is used as opposite to protract. In examples, any shortening, withdrawing, or receding means can be employed. In examples, the shortening, withdrawal, or recession can include folding, overlapping, compressing, closing, condensing, constricting, condensing, form into a bunch, sliding, rolling, winding, moving from an unstored position to a stored position, or any like movement and combination thereof. Additional examples by which protraction and retraction can be achieved for each component of safe box 200 is described herein.

For purposes of this disclosure, reference to any protractible and/or retractable structure, including any side member, bottom member, and lid, may be referred to as fully or partially “deployed” or in a full or partial “deployed state” when fully or partially protracted, and as fully or partially “stowed” or in a full or partial “stowed state” when fully or partially retraced. In examples, any protractible and/or retractable structure can be fully or partially deployed, fully or partially stowed, or any combination thereof.

Each of the front panel, side members, bottom member, and lid described herein can be independently selected to be any desired shape that allows for the functioning of the safe box 200. In examples, the front panel, side members, bottom member, and lid have the same or different shapes. In examples, the front panel, side members, bottom member, and lid have quadrilateral shapes. Other shapes can also be used such as circular, triangular, irregular, or any combination thereof. For the side members, bottom member, or lid that protract and retract, it should be understood that their shape as described is at least in the fully protracted state.

Any protractible and retractable structure as described herein and any panel, section, or slab of any such structure may also have any desired shape. In examples, each protractible and retractable structure as described herein and any panel, section, or slab of any such structure may independently have a shape that is quadrilateral, circular, triangular, irregular, or any combination thereof.

In examples, the front panel or facia 220 can be arranged to be generally parallel to front frame 202 and/or door 100. The side members 230, if two are present, can be arranged to be generally parallel to each other at least when in the protracted or partially protracted state. In examples, the bottom member 240 and the lid 250 can be arranged to be generally parallel to each other at least when in the protracted or partially protracted state. In examples, the bottom member 240 and the lid 250 can be arranged to include at least a respective portion thereof that is generally parallel to each other when in the stowed state.

In examples, a protractible and/or retractable panel, member, or lid refers to a structure that can be extended and/or collapsed by any means. In examples, a protractible and/or retractable panel, member, or lid, can be a collapsible panel system, sliding panel system, foldable panel system, a flexible sheet, a foldable lid, a combination of one or more panels and one or more flexible sheets, a combination of one or more sliding panel systems and one or more flexible sheets, or any combination thereof. In examples, protraction and/or retraction may be accomplished by way of sliding a structure. Sliding of a structure can be accomplished by any suitable means, such as for example, using a rails system, a slide, a channel, and wheels, or any like structure and any combination thereof. In examples, protraction and/or retraction may be accomplished by configuring at least one-part to slide relative to at least one other part. In examples, protraction and/or retraction may be accomplished so that one-part slides to overlap another part. In examples, protraction and/or retraction may be accomplished so that at least one-part stacks with at least another part. In examples, protraction and/or retraction may be accomplished by telescopically moving parts. In examples, protraction and/or retraction may be a combination of sliding and folding and/or unfolding.

Any suitable material that can provide a resilient structure can be used for the panels of the front panel and for any protractible/retractable panel system, or other panel that is used in the collapsible safe box either by itself of in combination with one or more sheets or other material. Exemplary materials for panels include powder coated steel, hemp steel flex, aluminum, galvanized, fiberglass, graphite carbon, and any combination thereof. The various panels can be all made of the same material. Alternatively, the material of each panel can be independently selected. In examples, a panel may be composed of one or more plates joined together. In examples, the plates making up a panel may be made of the same or different material from each other. In examples, the plates may include one or more of the above listed materials for the panels.

For purposes of this disclosure, the term “collapsible panel system” refers to a structure that includes two or more operably connected panels, sections or slabs. In examples, collapsible panel systems can be configured as a structured able to be collapsed, for example, by being compressed so that one or more panels, sections or slabs can slide relative to one or more of the other panels, sections, or slabs and become stacked and/or arranged parallel to each other. In examples, a collapsible panel system is set up to collapse and extend telescopically. In examples, the panels, sections, or slabs may include a hook or edge at their sides to engage with the next panel, sections, or slabs so that when sliding in one direction each panel, section, or slabs can pull on the next panel, section, or slab and thus expand, and when sliding in the opposite direction, the panels, sections, or slabs can become substantially overlapped and/or stacked. In examples, collapsible panel systems can allow for pivoting and/or folding of one panel, section, or slab relative to one or more other panels, sections, or slabs of the collapsible panel system. The connections can be made by any means that allow for the slide and/or rotation of the connected panels, sections, or slab about an axis. In examples as described herein, the panels, sections, or slabs may be connected by one or more hinges. In examples, hinges can be configured to extend along at least a portion of a panel, section, or slab. In examples, hinges can be configured to be located at a corner, edge, portion, or combination thereof of a panel, section, or slab. In examples, hinges can be configured to have a U-shape and be located only at end portions of a panel, section, or slab. Elements other than hinges can also be used. In place of hinges the invention can be implemented by fabric connections, or other joints. As used herein, section in reference to a collapsible panel system refers to one or more portions of the collapsible panel system and may include one or more panels or slabs. As used herein, “slab” in reference to a collapsible panel system refers to a contiguous body of material. In examples, a slab can be the same as a panel. In examples, a slab may be made of the same material as described for a panel.

The terms “sheet” or “flexible sheet” as used herein refer to a canvas or like sheet, or other body of flexible material that can fold or wrinkle when pushed together and can unfold or flatten when pulled or extended without breaking. Any sheet described herein can be made of a flexible material. Flexible materials can include rubber, cut resistant fabric or canvas, polymeric material as exemplified herein, or a combination thereof. The polymeric material can be poly-paraphenylene terephthalamide, also known as Kevlar®. The polymeric material can also be other materials that are likewise resistant to tempering. For example, the polymeric material can be a fluoropolymer, for example polytetrafluoroethylene (PTFE), also known as Teflon®.

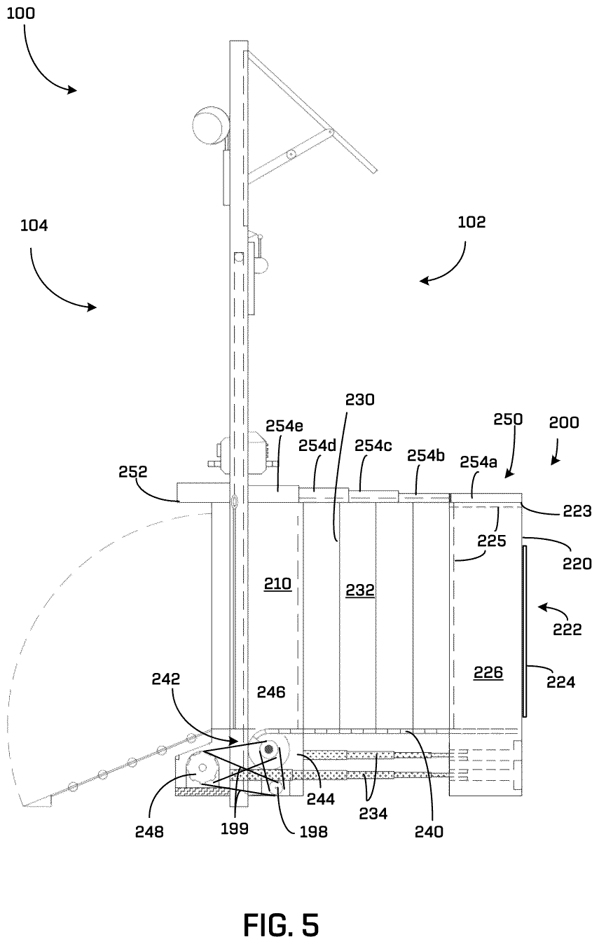

In examples, front panel or facia 220 can include one or more panels. In examples, front panel or facia 220 may include one panel. In examples, front panel or facia 220 may include a front surface 222 facing away from door 100. In examples, front surface 222 may be covered fully or in part by a cover 224 as for example shown in FIG. 5. In examples, cover 224 may include an ornamental design. In examples, cover 224 may include a display similar to display 130 described earlier.

In examples, front panel or facia 220 is sized sufficiently to cover side members 230 and bottom 240 when viewing safe box 200 from a front view. In examples, as illustrated, front panel or facia 220 may include one or more side end portions 226 that are curved. In examples, side end portions 226 may curve toward front frame 202 and/or door 100. In examples, a side end portion 226 may have an edge facing front frame 202 and/or door 100. In examples, a first end portion 226a and a second end portion 226b of front panel 220 define a middle portion 228 of front panel 220. In examples, middle portion 228 of front panel 220 can be parallel to front frame 202 and/or door 100. In examples, side end portions 226 can be angled perpendicular to a middle portion 228 of front panel or facia 220, thus having an edge facing toward front frame 202 and/or door 100.

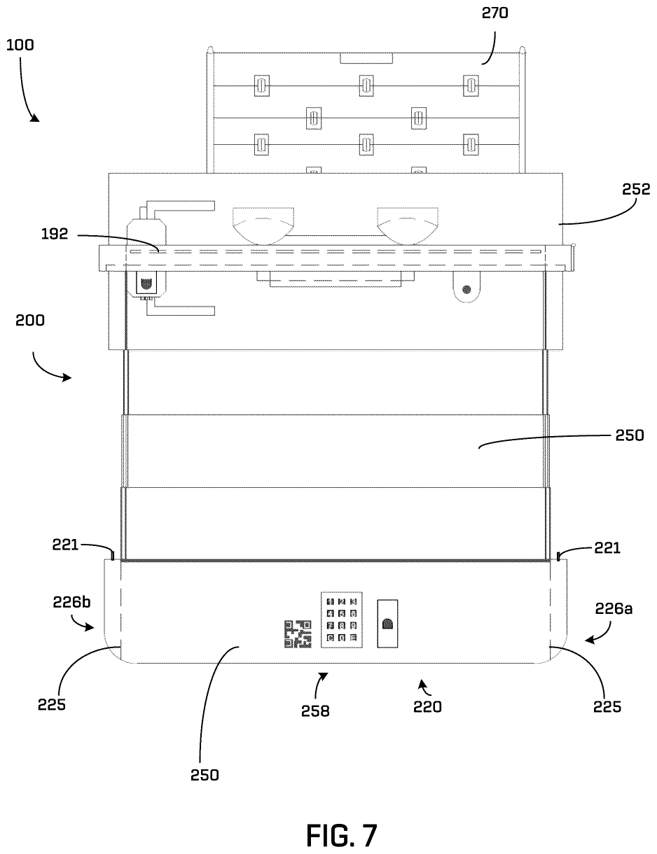

In examples, as shown in FIG. 7, front panel or facia 220 may include one or more fasteners 221 along an edge of one or more side end portions 226 to engage with front frame 202. Fasteners 221 may include any suitable structure. In examples, fasteners 221 may include loop and hook, fittings, pins, magnets, or any combination thereof. In examples, front frame 202 may include complementary mating structures to engage fasteners 221. In examples, front panel or facia 220 may include an upper edge 223. In examples, upper edge 223 extends the full length of front panel or facia 220 from a first side end portion 226a to a second side end portion 226b along an upper portion of front panel or facia 220. In examples, upper edge 223 of front panel 220 may be configured to be engaged by lid 250. In examples, lid 250 may include a groove to engage upper edge 223.

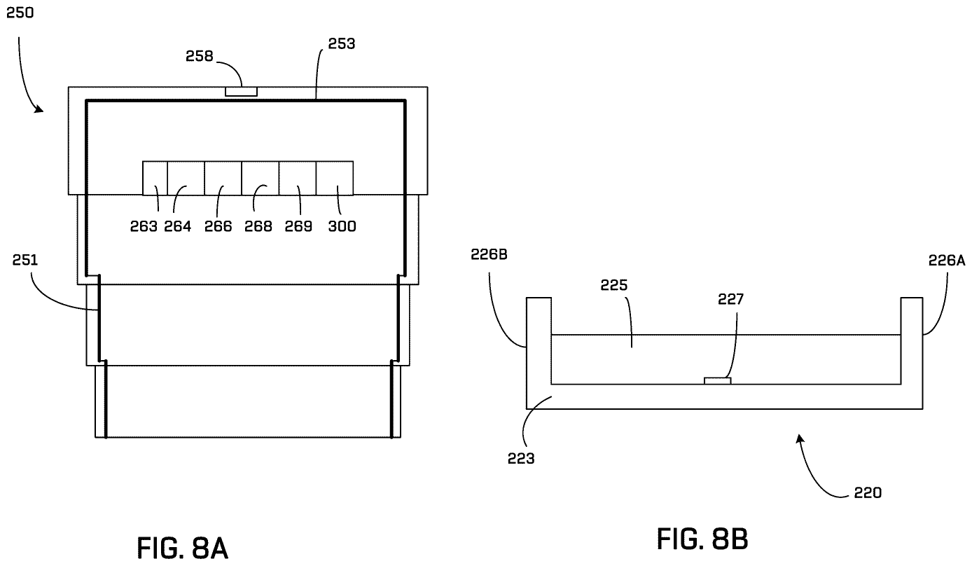

As illustrated in FIGS. 5 and 8B, in examples, front panel or facia 220 may include a rim 225. In examples, rim 225 can extend from front panel 220 toward front frame 202 and/or door 100. In examples, rim 225 may circumscribe middle portion 228 of panel 220 extending between end portions 226a and 226b. In examples, the width of rim 225 extending from front panel 220 toward front frame 202 and/or door 100 can be the same or different from the width lid 250 extends from door 100 when in the fully stowed position. In examples, rim 225 can improve structural integrity of safe box 200. In examples, the top portion of rim 225 may be below upper edge 223 of front panel 220. In examples, a top portion of rim 225 is configured to fit under lid 250 when safe box 200 is fully collapsed. In examples, a bottom portion of rim 225 may be configured to connect to, hold, support, or any combination thereof bottom member 240. In examples, one or more side portions of rim 225 may be configured to connect to, hold, support, or any combination thereof one or more side members 230. Connections between rim 225 and bottom member 240 and/or a side member 230 may be made by any suitable fastener. For example, fasteners can include screws, bolts, fittings, pins, brackets, adhesives, magnets, or any combination thereof. In examples, a connection may also be made by welding. In examples, rim 225 can be made of any material as previously described for any panel discussed herein.

As shown in FIG. 8B, in examples, front panel 220 may include one or more locking mechanisms to engage directly or indirectly one or more locks provided on lid 250. In examples, locking mechanism 227 may provide a structure designed to be engaged by lock 258 of lid 250. In examples, locking mechanism 227 may be controlled by lock 258. In examples, locking mechanism 227 may be a passive structure. In examples, locking mechanism 227 may be provided on rim 225. In examples, locking mechanism 227 may be provide on front panel 220.

In examples, each of the one or more side members 230 can include either a collapsible panel system, a flexible sheet, a combination of panels and sheets, a combination of collapsible panel system and flexible sheets, or any combination thereof. Each side member 230 can be the same or different from any other side member 230. In examples, at least one side member can be a collapsible panel system. In examples, each side member can include a collapsible panel system. In examples, at least one side member of the safe box 200 can include a rubber or rubber like material sheet. In examples, at least one side member can include a sheet of cut resistant fabric or canvas. In examples, at least one side member can include of a sheet of polymeric material. In examples, at least one side member can include a sheet of flexible material. In examples, at least one side member can include a combination of panels and sheets. In examples, at least one side member can include a structure having alternating panels and sheets. In examples, each side member can include a structure having alternating panels and sheets. In examples, each side member can include a structure having stackable panels and/or sheets. In examples, at least one side member is configured to protract and/or retract telescopically. In examples, at least one side member is configured to protract and/or retract by overlapping the panels and/or sheets. In examples, at least one side member is configured to protract and/or retract via an accordion fold. In examples, each side member is configured as an accordion fold type structure.

In examples, one or more side members 230 may include alternating rows of panels, sheets, or a combination of both. In examples as illustrated, safe box 200 may include two side members 230, each having rows of panels 232. In examples, the one or more side members 230 can be configured to protract and retract sliding panels 232 to/from a stacked and/or parallel positions. In examples, the one or more members 230 can be configured to protract and retract telescopically. In examples, the panels of a side member 230 may include a hook or edge at their sides to engage with the next panel so that when sliding in an expanding direction each panel can catch and pull on the next panel and thus expand. In examples, when sliding in retracting direction, the panels can become substantially overlapped and/or stacked and collected at a stowing location. In examples, as described, the stowed location may be within border 210.

In examples, one or more side members 230 may be connected at one end to front frame 202, back frame 204, and/or door 100. In examples, one or more side members 230 may be connected to at one end to front panel 220 and/or rim 225. In examples, a side member 230 is connected at a first end to front frame 202, back frame 204, and/or door 100, and connected at a second end, opposite the first end, to front panel 220 and/or rim 225. The connection to front frame 202, back frame 204, door 100, front panel 220, and/or rim 225 may be made by welding, adhesive, magnets, one or more fasteners, or any combination thereof. In examples, fasteners may include screws, bolts, fittings, brackets, pins, hooks, or any like structure. In examples, a side member 230 may be operably connected to bottom member 240. In examples, the operable connection between a side member 230 and bottom member 240 may be by any mechanical means that allows for the protraction and retraction of side member 230 and the of bottom member 240. In examples, one or more sliding tracks or like structure may be used to operably engage a side member 230 with bottom 240. In examples, one or more channel backets, such as for example, the one or more C-channel brackets may wrap around an edge of bottom member 240. In examples, a C-channel bracket may include one or more pins connected to a panel, section, or slab of a side member 230. In this manner, as side member 230 and bottom member 240 expand, side member 230 and bottom member 240 are kept together. In examples, as the side member 230 collapses, the C-channel brackets may collect along with the side member panels, sections, or slabs as described.

The protraction and retraction of the one or more side members 230 may be effectuated by any suitable mechanism. In examples, safe box 200 may include one or more telescoping arm 234. In examples, safe box 200 may include two telescoping arms 234a and 234b. In examples, a telescoping arm can be located proximate to a side member 230 and a bottom member 240. In examples, a telescoping arm 234 can be operably connected to side member 230. In examples, a telescoping arm 234 can be operably connected to bottom member 240. In examples, a telescoping arm 234 may be operably connected to a side member 230 and bottom member 240. In examples, safe box 200 may include two telescoping arms 234a and 234b, a first telescoping arm 234a being operably connected to a first side member 230a, and a second telescoping arm 234b being operably connected to a second side member 230b. Optionally, first and/or second telescoping arms 234a and 234b may also be connected to bottom member 240. In examples, a telescoping arm 234 may be operably connected only to side member 230. In examples, a telescoping arm 234 may be operably connected to an end portion of side member 230 that is opposite a second end portion of side member 230, the second end portion of side member 230 being adjacent the bottom member 240. In examples, a telescoping arm 234 may be operably connected to an end portion of each side member 230 that is respectively opposite a second end portion of each side member 230, the second end portion of each side member 230 being adjacent the bottom member 240. In examples, safe box 200 may include more than two telescoping arms. In examples, safe box 200 may include one, two, three or four telescoping arms 234.

In examples, a telescoping arm 234 can be arranged along any portion of a side member 230. In examples, as a telescoping arm 234 extends it may be configured to cause a side member 230 that is operably connected thereto to protract. In examples, as a telescoping arm extends an operably connected side member 230 extend by sliding panels 232 from an overlapping or substantially overlapping position to a serial or substantially non-overlapping position. In examples, as a telescoping arm 234 retracts it may be configured to cause a side member 230 that is operably connected thereto to retract. In examples, as a telescoping arm retracts an operably connected side member 230 collapses by sliding panels 232 to a stacked position in which panels 232 are in an overlapping or substantially overlapping position.

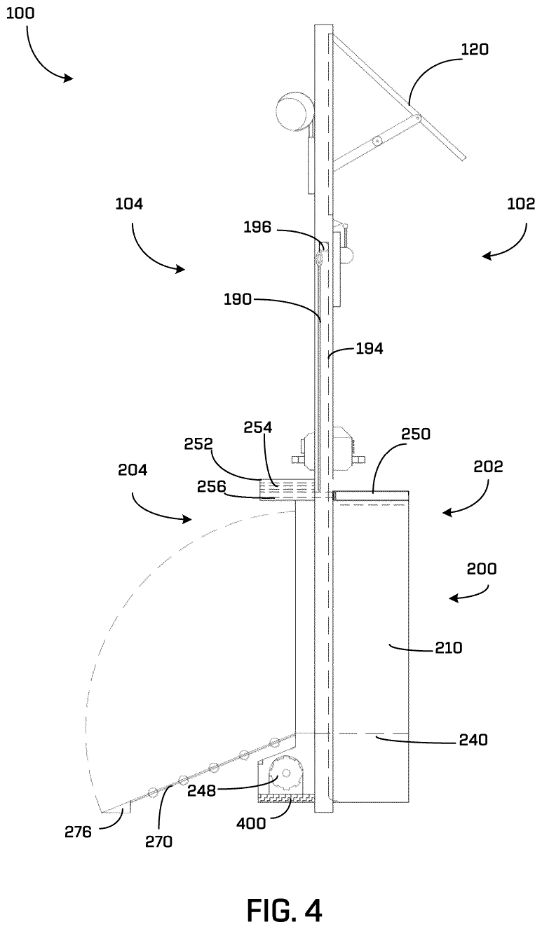

In examples, as illustrated in FIG. 4, a side view of door 100, a side member 230 and operably connected telescoping arm(s) 234 may be arranged such that when side member 230 is in a collapsed stated, sliding panels 232 are stacked and substantially overlapping each other and at least a portion of border 210. In this manner, when safe box 200 is collapsed, side members 230 may be contained within front frame 202.

In examples, a telescoping arm 234 may be connected to front panel 220 and/or rim 225. In examples, a telescoping arm 234 may be connected to front frame 202, back frame 204, and/or door 100. The connections between telescoping arm 234 and any of front panel 220, rim 225, front frame 202, back frame 204, and/or door 100 can be may by welding, adhesive, magnets, one or more fasteners as described herein, or any combination thereof. In examples, a telescoping arm 234 may be connected at a first end to front frame 202, back frame 204, and/or door 100 and at a second, opposite end to front panel 220. In examples, as a telescoping arm 234 extends it may cause at least a portion of the front panel 220 to translate away from front frame 202 and/or door 100. In examples, as a telescoping arm 234 retracts it may cause at least a portion of the front panel 220 is translated toward front panel 202 and/or door 100.

The one or more telescoping arms 234 may be operated manually, electronically, hydraulically, mechanically, automatically, independently, or any combination thereof. In examples, the telescoping arm 234 may be configured to lock in position once extended and/or retracted to a given amount. In examples, each telescoping arm 234 can be configured to fully extend, fully retract, partially extend, partially retract, or any combination thereof.

In examples, the protraction and retraction of bottom member 240 operably engaged to a side member 230 and/or telescoping arm 234 may cause the protraction and retraction of telescoping arm 234 and/or a side member 230. In examples, the extension and retraction of a telescoping arm 234 may be configured to be performed manually by pulling from or pushing against the front panel 220. In examples, the extension and retraction of a telescoping arm 234 may be caused by a motor (not shown). In examples, the extension and retraction of a telescoping arm 234 may be caused by a pulley system, gears, hydraulics, electric motor, or other like mechanism. In examples, the extension and retraction of a telescoping arm 234 can be controlled remotely. In examples, remote control can be done via controller 300, directly, or both. Remote control can be performed as similarly described earlier with respect to other components. In examples, remote communication can occur via any wireless means such as for example wi-fi, blue tooth, RF signals, and the like. In examples, operation of a telescoping arm 234 may be controlled by a remote controller, smart device such as a smart phone, computer or other computing device. In examples, a telescoping arm 234 can be operated by controller 300. In examples, a telescoping arm operation system may include memory, logics, instructions, a controller or other processing unit, a transceiver or may be in communication with a memory, logics, instructions, a controller or other processing unit, a transceiver that may be used for remote control and/or operation of the telescoping arm and of any motor used to operate the telescoping arm.

In examples, the bottom member 240 can include either a collapsible panel system, a flexible sheet, a combination of panels and sheets, a combination of collapsible panel system and flexible sheets, or any combination thereof. In examples, the bottom member can be a collapsible panel system. In examples, the bottom member can include a collapsible panel system. In examples, the bottom member of the safe box 200 can include a rubber or rubber like material sheet. In examples, the bottom member can include a sheet of cut resistant fabric or canvas. In examples, the bottom member can include of a sheet of polymeric material. In examples, the bottom member can include a sheet of flexible material. In examples, the bottom member can include a combination of panels and sheets. In examples, the bottom member can include a structure having alternating panels and sheets. In examples, the bottom member can include a structure having alternating panels and sheets. In examples, the bottom member is configured to protract and/or retract telescopically. In examples, the member is configured to protract and/or retract by overlapping the panels and/or sheets.

In examples, bottom member 240 can include a collapsible panel system can allow for pivoting and/or folding of one panel, section, or slab relative to one or more other panels, sections, or slabs of the collapsible panel system. In examples, bottom member 240 can include panel system that can allow two or more panels, sections, or slabs operably connected to allow them to be wound about a roller. The connections can be made by any means that allow for the slide and/or rotation of the connected panels, sections, or slab about an axis. In examples as described herein, the panels, sections, or slabs may be connected by one or more hinges. In examples, hinges can be configured to extend along at least a portion of a panel, section, or slab. In examples, hinges can be configured to be located at a corner, edge, portion, or combination thereof of a panel, section, or slab. In examples, hinges can be configured to have a U-shape and be located only at end portions of a panel, section, or slab. Elements other than hinges can also be used. In place of hinges the invention can be implemented by fabric connections, or other joints. In examples, the bottom member can be configured to protract and/or retract as a curtain. In examples, a roller system, a track system, rail system, channel system, wheel system, slide system, or any other suitable mechanism may be used to allow for protraction and/or retraction of the bottom member. In examples, the bottom member is configured to protract and retract via an accordion fold. In examples, the bottom member is configured as an accordion fold type structure. In examples, the bottom member includes a structure of alternating panels and sheets configured to protract and retract in an accordion manner.

In examples, as illustrated, bottom member 240 may include rows of sheets, panels, or both. In examples, the bottom member 240 can be configured to protract and retract in an accordion type of fold. In examples, the bottom member 240 can be configured to protract and retract in a curtain style manner. In examples, the bottom member 240 can be configured to protract and retract by way of a track system. In examples, the bottom member 240 can be configured to protract and retract by sliding one or more panels to overlap or substantially overlap one or more other panels.

In examples, the bottom member 240 may be operably connected to one or more telescoping arms 234. The operation, control, and arrangement of the one or more telescoping arms 234 may be as already described earlier. In examples, the bottom member 240 may be operably connected to two telescoping arms. In examples, a first end portion of bottom member 240 is operably connected to a first telescoping arm 234a, and a second end portion, opposite the first end portion, of bottom member 240 is operably connected to a second telescoping arm 234b. In examples, as a telescoping arm 234 extends it can be configured to cause at least a portion of bottom member 240 to protract. In examples, as a telescoping arm 234 retracts it can be configured to cause at least a portion of bottom member 240 to retract. In examples, the one or more telescoping arms 234 can cause at least a portion of bottom member 240 to fully protract, fully retract, partially protract, partially retract, or any combination thereof. In examples, the bottom member 240 is operably connected to a telescoping arm that is also operably connected to a side member 230. In examples, bottom member 240 may be operably connected to an independent telescoping arm not connected to a side member 230.

In examples, as illustrated, bottom member 240 may be configured to protract and retract via a roller or winding system, or similar mechanism 242. In examples, roller or winding system 242 may be configured to couple with front frame 202 and/or door 100. In examples, roller or winding system 242 may include a housing 244. In examples, roller or winding system 242 may be located within an area defined by border 210. In examples, roller or winding system 242 may be located within front frame 202. In examples, where roller or winding system 242 includes a housing 244, housing 244 may also be located within front frame 202 and/or within an area defined by border 210. In examples, roller or winding system may be located at a bottom portion of safe box 200. In examples, a roller or winding system 242 may include a rotating center body able to rotate clockwise and counterclockwise about a central axis. In examples, the center body 246 can be cylindrical. In examples, the center body can be prismatic. In examples, the roller or winding system 242 may be operated manually, by a motor 248, or any combination thereof. In examples, roller or winding system 242 may operate automatically. In examples, roller or winding system 242 may operate mechanically, hydraulically, electrically, or any combination thereof. In examples, roller or winding system 242 may be controlled by controller 300. In examples, roller or winding system 242 may be controller via a separate control mechanism. In examples, roller or winding system 242 may be controller remotely via a transceiver using wireless communication such as via any wireless means such as for example wi-fi, blue tooth, RF signals, and the like as previously described for other components. In examples, remote control can be done via controller 300, directly, or both.

In examples, as illustrated, bottom member 240 can be configured to wind and unwind using a roller system 242. In examples, bottom member 240 may include more flexible sheet material to allow for easier winding. In examples, bottom member 240 may include only flexible sheet material. In examples, bottom member 240 may include a panel system or a series of panels 241 connected by hinges. In examples, bottom member 240 may include alternating rows of flexible sheet and panels. In examples, when using roller system 242, any panel used for bottom member 240 may be sized to allow for winding about rotating center body 246. A roller system 242 or similar mechanism can be installed to support a first end portion of bottom member 240. In examples, a first end of bottom member 240 may be connected to a rotating center body 246 of roller system 242. As the center body 246 of roller system 242 rotates bottom member 240 can either retract or protract depending on whether it is being wound or unwound. In examples, in a fully retracted stated, or stowed state, at least a portion of bottom member 240 can be located wound about center body 246. In examples, in the stowed or partially stowed state, at least a portion of bottom 240 is located inside housing 244. In examples, in its fully stowed state at least a portion of bottom member 240 may remain parallel to at least a portion of lid 250 when also in a fully stowed position. In examples, the degree of protrusion and/or retraction of bottom member 240 may be controlled via the roller mechanism 242 by controlling the amount of rotation.

In examples, as illustrated, roller system 242 and/or motor 248 may be operationally engaged to door hatch reel or clog 198. The operable engagement may be made via any suitable means such as chains, belts, one or more gears or like structures. In examples, the operable engagement is configured to rotate reel or clog 198 before and/or after rotating center body 246 of roller system 242. In examples, the operable engagement is configured to rotate reel or clog 198 while rotating center body 246 of roller system 242. In examples, the operable connection may be such that as roller system 242 is operated to protract bottom member 240, reel or clog 198 is rotated to cause door hatch 190 to close opening 180. Similarly, as roller system 242 is operated to retract bottom member 240, reel or clog 198 may be rotated to cause door hatch 190 to open opening 180.

In examples, where reel or clog 198 is operated by its own independent motor, the operation of reel or clog 198 may be coordinated with that of roller system 242. In examples, controller 300 may coordinate the operation of reel or clog 198 and roller system 242.

In examples, as illustrated, door hatch 190 may be a single panel that moves vertically to open and close opening 180 using a pulley 196 and one or more cables 194. In examples, as reel or clog 198 rotates, one or more cables 194 can be wound or unwound from reel or clog 198 causing door hatch 190 to rise or lower. In examples, as roller system 242 is operated to protract bottom member 240, reel or clog 198 may be caused to rotate and cause door hatch 190 to be lowered. Likewise, in examples, as roller system 242 is operated to retract bottom member 240, reel or clog 198 may be caused to rotate to cause door hatch to be raised.

In examples, the operation of door hatch 190 may be separate and independent of the operation of roller system 242 and/or of bottom member 240. In examples, door hatch 190 may be caused to open or close opening 180 only either after full expansion of safe box 200 or before initiating collapsing safe box 200. For example, door hatch 190 may remain in its stowed position, thus leaving opening 180 unobstructed until safe box 200 is fully deployed. Once safe box 200 is fully deployed, then door hatch 190 may be caused to close opening 180. The coordination of this operations may be made by controller 300. For example, once full deployment of safe box 200 is determined, controller 300 can trigger a signal to close opening 180 using door hatch 190. Likewise, in examples, door hatch 190 can be triggered to withdraw to free opening 180 before safe box 200 initiates its retraction. In examples, once safe box 200 is triggered to initiate retraction, either automatically or manually, first a signal may be triggered to cause door hatch 190 to withdraw and free opening 180, then safe box 200 may commence retraction. As stated earlier, controller 300 may be configured to coordinate the operations of safe box 200 and door hatch 190.

In examples, one or more belts, chains, or gears may be used to operatively couple motor 248 with central body 246 of winding system 242 and one or more belts, chains, or gears may be used to operatively couple motor 248 with reel or clog 198. In examples, motor 248 may be operatively coupled only to central body 246 of winding system 242. In examples, motor 248 may be operatively coupled only to reel or clog 198. In examples, central body 246 of winding system 242 may be coupled using one or more belts, chains, or gears to reel or clog 198. In operation central body 246 and reel or clog 198 may be caused to rotate in the same or opposite directions.

In examples, by coordinating the opening and closing of opening 180 via door hatch 190 with the protraction and retraction of bottom member 240, it is possible to ensure that opening 180 is being closed as safe box 200 is being deployed. In examples, opening 180 is fully closed when safe box 200 is fully deployed. In examples, opening 180 is fully open when safe box 200 is fully stowed. In this manner added security may be provided by blocking a potential entry to the room or building to which door 100 is configured to block access when safe box 200 is deployed.

In examples, the coordinating of opening and closing of opening 180 via door hatch 190 with the deployment of safe box 200 may allow for transition of an item, parcel, or packaged deposited in safe box 200 to the room or building to which door 100 blocks entry when closed. In examples, as safe box 200 is deployed, opening 180 is closed by door hatch 190. An item, parcel, or packaged may then be safely deposited inside safe box 200 without risk of entry through opening 180. After the item, parcel, or package has been placed in safe box 200, lid 250 may be closed and locked. Safe box 200 may then either manually or automatically return to a stowed or collapsed state. In examples, as safe box 200 collapses, bottom member 240 is retracted while door hatch 190 is operated to open opening 180. In examples, door hatch 190 is operated to open opening 180 before initiating collapsing the safe box 200 and/or before retracting bottom member 240. In examples, as safe box 200 collapses to its stowed position, the item, parcel, or package therein may be pushed through opening 180 and enter the room and/or building from which door 100 blocks access when closed.

As shown in FIGS. 2 to 7, in examples, back frame 204 may include a ramp 270 with one or more wheels 272. In examples, ramp 270 may extend from opening 180. In examples, ramp 270 can be joined to back frame 204 via one or more pivotal joints 274. A pivotal joint may include a hinge or like structure. In examples, ramp 270 may include a generally planar structure including one or more plates, sections, or slabs. In examples, ramp 270 can be made of metal, such as steel, aluminum, iron, or any other metal, plastic, or any combination thereof. In examples, wheels 272 may made of steel and/or plastic. In examples, a top surface of ramp 270 may be configured to allow an item, parcel, or package to slide across it. In examples, one or more wheels 272 may be included to promote transit of an item, parcel, or package along a top surface of ramp 270. In examples, when not in use or if desired, ramp 270 may be pivoted upward to achieve a vertical position where ramp 270 is parallel or substantially parallel to door 100. In examples, delivery of an item, parcel, or package may cause ramp 270 to pivot downward to allow transit of an item, parcel, or package. In examples, ramp 270 may include a clip 276 configured to engage a portion of back frame 204 to hold ramp 270 in an upright position. In examples, clip 276 may be automatically released to allow for ramp 270 to deploy when and/or in response to a signal being received to trigger deployment of safe box 200.

In examples, the lid 250 of a safe box as described can be a protractible/retractable lid. In examples, lid 250 may be a collapsible lid. In examples, lid 250 may be a stackable lid. In examples, lid 250 may be a telescoping lid. In examples, the lid 250 can include a collapsible panel system in which one section of lid 250 can be stacked and/or slide to overlap or substantially overlap the next section of lid 250. In examples, the lid can include a collapsible panel system with two or more panels, sections, or slabs slidably joined. In examples, two or more panels, sections, or slabs may be configured to slide relative to each other to achieve a stacked arrangement. In examples, the lid can include a collapsible panel system with at least three panels, sections, or slabs. In examples, the lid can include a collapsible panel system with at least four panels, sections, or slabs. Each panel, section, or slab of the collapsible panel system included in the lid can have the same or different size as one or more of the other panels, sections, or slabs. In examples, a lid can include either a collapsible panel system, a flexible sheet, a combination of panels and sheets, a combination of collapsible panel systems and sheets, or any combination thereof as described herein for the side member and/or bottom member. A lid can be configured to allow for full extension of the lid, partial extension of the lid, full retraction of the lid, partial retraction of the lid, or any combination thereof. In examples, a lid may be configured to allow sliding of the lid to close the safe box when the safe box partially collapsed. In examples, a lid may be configured to close the safe box when the safe box is fully extended. In examples, the lid may be configured to close the safe box at varying degrees of extension as exemplified in more detail below.

In examples, lid 250 may be configured to protract and/or retract between a stowed and deployed states. In examples, lid 250 is articulated. In examples, lid 250 is not articulated. In examples, lid 250 is formed of an unbendable panel. In examples, lid 250 is flat when fully protracted, partially protracted, or both.

As illustrated in FIGS. 4 to 7, in examples, lid 250 may be transitioned from a stowed state to a deployed state, and back to a stowed state. In examples, lid 250 may be configured to slide or travel along a track, slide, or other like structure. In examples, lid 250 may configured to slide into a housing provided on back frame 204. For example, as illustrated, back frame 204 may include a lid housing portion 252. In examples, lid housing portion 252 may be a hollow structure. In examples, lid housing portion 252 may have a width that is the same or larger than the width of lid 250. In examples, lid housing portion 252 may include sufficient space to house a collapsed lid 250. In examples, as lid 250 is retracted, it may be configured such that one or more panels, sections, or slabs 254 that make up lid 250 slide into lid housing portion 252. In examples, the one or more panels 254 that slide into lid housing portion 252 can be stacked or arranged horizontal to each other when in lid housing portion 252. In examples, two or more panels, sections, or slabs 254 can telescopically collapse into lid housing portion 252. In examples, two or more panels, sections, or slabs 254 can overlap or substantially overlap while in a stowed position inside lid housing portion 252. In examples, one or more panels, sections, or slabs 254 of lid 250 that reach lid housing portion 252 may travel through door 100.

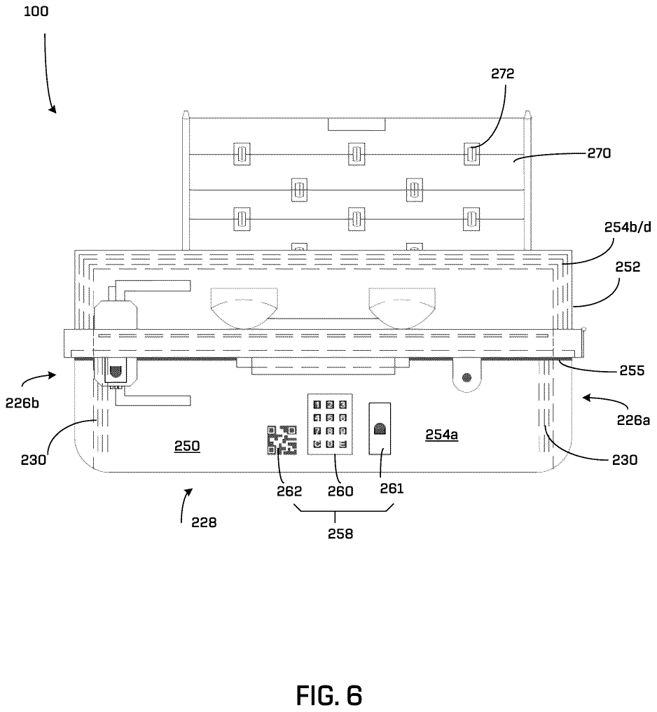

In examples, when lid 250 is in a stowed position, at least one panel, section, or slab 254 (illustrated as 254a in FIG. 6) may extend from door 100 so as to remain exposed and function as a top cover for safe box 200. In examples, this at least one panel, section or slab of lid 250 extending from door 100 when lid 250 is a fully stowed state may house one or more of the electronic devices provided in safe box 200, including for example safe box lock 258 as well as one or more of other electronic components as illustrated, for examples, in FIG. 8A.

In examples, when lid 250 is in a stowed position, one or more panels, sections, or slabs 254 extend from lid housing portion 252 to at least a portion of the thickness of door 100. In examples, when lid 250 is in a stowed position, at least a portion of lid 250 may function as a block for door hatch 190. In examples, when lid 250 is in a stowed position, lid 250 may function as a means to keep door hatch 190 in an open position, i.e. not covering opening 180. In examples, lid 250 may continue to block operation of hatch 190 until lid 250 is fully extended or deployed. In examples, all the panels, sections, or slabs that make up lid 250 may be configured to move through door 100 in an initial deployment step of lid 250 and/or safe box 200, freeing operation of door hatch 190. In this latter examples, operation of hatch 190 may occur while lid 250 and/or safe box 200 continues to expand. In examples, upon retraction of lid 250 and/or safe box 200, the panels, sections, or slabs that make up lid 250 may be configured to first collect and/or stack at a front portion 102 of door 100 before transitioning to housing portion 252. In this manner, lid 250 does not block operation of door hatch 190, which may then be operated simultaneously while lid 250 and/or safe box 200 is being collapsed. In the alternative, door hatch 190 may be operated prior to collapsing of lid 250 and/or safe box 200. In these latter examples, the system may allow the panels, sections, or slabs that make up lid 250 to enter housing portion 252 while being collapsed and/or stacked.

In examples, one or more panels, sections, or slabs 254 may be configured to extend and compress using a track system 256. In examples, track system 256 may include a track and bearing system, a track and wheel system, slide and pin, a belt system, a hydraulic system, or any other suitable mechanism that can allow for the insertion and extraction of lid 250.

In examples, the one or more panels, sections, or slabs 254 may include a hook or edge at their sides to engage with the next panel so that when sliding in an expanding direction each panel can catch and pull on the next panel and thus expand. In examples, when sliding in retracting direction, the panels can become substantially overlapped and/or stacked and collected at a stowing location. In examples, the panels, sections, or slabs 254 of a lid 250 may of decreasing size so that as lid 250 retracts one panel, section, or slab may fit under the next panel, section or slab. In examples, at least one panel, section, or slab, for example as illustrated by 254a may remain unstacked and does not slide under one other panel, section, or slab.

In examples, when lid 250 is fully retracted, or partially retracted, i.e. in a stowed or partially deployed state, at least a portion of lid 250 may be orthogonal to at least a portion of door 100. In examples, deployment of lid 250 can be caused manually. In examples, deployment of lid 250 may be automatic. In examples, safe box 200 may include a motor operably connected to lid 250 and configured to deploy and/or retract lid 250. In examples, deployment and/or retraction of lid 250 may be controlled by a controller 300, manually, or by remote control.

In examples, when in the stowed state, at least a portion of lid 250 may be configured to extend from front side 202 of door 100. In examples, when in the stowed state, at least a portion of lid 250 may be configured to extend from front side 202 of door 100 by a distance that equals a dimension of border 210 that is orthogonal to door 100. In examples, when in the stowed state, at least a portion of lid 250 may be configured to lay flat over a top portion of safe box 200. In examples, when in the fully stowed state, at least a portion of lid 250 may be configured to lay horizontal to the bottom portion of safe box 200. In examples, collapsible lid 250 may include a single panel, section, or slab. In examples, collapsible lid 250 may include two or more operably joined panels, sections, or slabs. In examples, collapsible lid 250 may include three or more operably joined panels, sections, or slabs. In examples, collapsible lid 250 includes more than four operably joined panels, sections, or slabs. In examples, lid 250 is an articulated lid with two or more panels, sections, or slabs pivotally joined. In examples, as shown in FIG. 6, lid 250 may include at least one pivot joint 255. Any pivot joint can be used, for example, a hinge can provide a pivot joint. In examples, collapsible lid 250 includes multiple pivotally joined panels, sections, or slabs. In examples, the panels, sections, or slabs may be joined in a serial manner. For example, collapsible lid 250 may include up to five panels, sections, or slabs, six panels, sections, or slabs, ten panels, sections, or slabs, fifteen panels, sections, or slabs, twenty panels, sections, or slabs, thirty panels, sections, or slabs, forty panels, sections, or slabs, fifty panels, sections, or slabs, or a hundred panels, sections, or slabs. In examples, lid 250 may be configured to extend from door 100 at least as far as bottom member 240. In examples, lid 250 may be a collapsible lid with at least five panels, sections, or slabs 254a, 254b, 254c, 254d, and 254e. As illustrated, in examples, the size of the panels, sections, or slabs, can decrease as the panels, sections, or slabs get farther away from door 100 when lid 250 is in the extended state such that one panel, section, or slab, can house an adjacent panel, section, or slab when in the collapsed state. In examples, the panels, sections, or slabs may be configured to contract and protract telescopically. In examples, one panel, section, or slab 254a may be operatively joined to panel, section, or slab 254b, panel, section, or slab 254b may be operatively joined to panel, section, or slab 254c, panel, section, or slab 254c may be operatively joined to panel, section, or slab 254d, and panel, section, or slab 254d may be operatively joined to panel, section, or slap 254e. In examples, panel, section, or slab 254e may be operatively connected to front frame 202, back frame 204, and/or door 100. In examples, panel, section, or slab 254e may be operatively connected to back frame 204, and/or door 100 via a track 256. The panels, sections, or slabs of lid 250 can be the same as the sections previously discussed with respect to the collapsible panel systems.

In examples, one or more panels, sections, or slabs 254 may be removably connected to one or more other panels, sections, or slabs 254, back frame 204, front frame 202, and/or door 100. In examples, at least panel, section, or slab 254a of lid 250 may be removably connected. In examples, having a panel, section, or slab 254 of lid 250 be removably connected may allow for the replacement of that panel, section, or slab in the event it or any components thereon require replacement or servicing. In examples, one panel of lid 250 may include one or more electronics components of lid 250 as described and may be removably connected to one or more other panels. In examples, a removable panel of lid 250 may include controller 300. In examples, a panel of lid 250 that include one or more electronic components and/or controller 300 may be removed for service and/or replacement by a new panel with same, similar, or additional electrical components. For example, as illustrated, panel 254a may be a replaceable panel, section, or slab of lid 250 that includes all the electronic components as described and as illustrated in FIG. 8A.

In examples, each panel, section, or slab of lid 250 may be independently sized. In examples, all panels, sections, or slabs of collapsible lid 250 may have the same length. For purposes of this description, the length of a panel, section, or slab of lid 250 refers to the dimension of that panel, section, or slab that is orthogonal to door 100 and/or extending in the direction that intersects the thickness of door 100. In examples, at least one panel, section, or slab of collapsible lid 250 has a length that is different from the size of at least one other panel, section, or slab of collapsible lid 250. In examples, at least one panel, section, or slab of collapsible lid 250 has a length that is the same as the size of at least one other panel, section, or slab of collapsible lid 250. In examples, a lid 250 may include a collapsible lid with five panels, sections, or slabs in which four panels, sections, or slabs, such as panels, sections, or slabs 254b, 254c, 254d, and 254e, have the same length, and one panel, section or slab, such as section 254a, has a length different from that of panels, sections, or slabs 254b, 254c, 254d, and 254e. In examples, every panel, section, or slab of a collapsible lid 250 has the same width as any other panel, section, or slab. In examples, every panel, section, or slab of a collapsible lid 250 has a different width as any other panel, section, or slab. For purposes of this discussion, a width of a panel, section or slab refers to the dimension that is horizontal to door 100.

The size of each panel, section, or slab of collapsible lid 250 is not particularly limited. In examples, one or more panels, sections, or slabs of a lid 250 may have a lateral width ranging from 10 inches to 90 inches, 10 inches to 80 inches, 10 inches to 70 inches, 10 inches to 60 inches, 10 inches to 50 inches, 10 inches to 40 inches, 10 inches to 30 inches, or 10 inches to 20 inches. In examples, the lateral width of one or more panels, sections, or slabs of lid 250 may be 20 inches to 40 inches, 25 inches, 30 inches, or 35 inches. The longitudinal length of one or more panels, sections, or slabs of an articulated lid 250 is also not limited. In examples the one or more sections may have a longitudinal length of at least 0.1 inch and not greater and 1 inch, 2 inches, 3 inches, 4 inches, 5 inches, 6 inches, 7 inches, 8 inches, 9 inches, 10 inches, 11 inches, 12 inches, 13 inches, 14 inches, 15 inches, 16 inches, 17 inches, 18 inches, 19 inches, 20 inches, 25 inches, 30 inches, 40 inches, or 50 inches. In examples, first, second, third, fourth, and fifth panel, section, or slab 254, may have a longitudinal length of 6 inches.

FIG. 4 illustrates a top down view of an example of a safe box 200 fully collapsed or fully in a stowed state. As illustrated, in examples, panel, section, or slab 254a may fit over a portion of a front panel 220, when safe box is fully collapsed. In examples, front panel 220 may abut against an outer edge of lid 250 when lid 250 is engaged to front panel 220. In examples, at least when safe box 200 is fully collapsed, front panel 220 and/or rim 225 may also slide under an edge of lid 250. In examples, when lid 250 is engaged to front panel 220 the front surface of front panel 220 may be flush with at least a portion of a front edge of lid 250. In examples, when lid 250 is engaged to front panel 220 the upper edge 223 of front panel 220 may engage one or more grooves provided on the under surface of lid 250.

In examples, it may be desirable and/or necessary to fully deploy safe box 200 to fit an item or package. In examples, safe box 200 may be partially deployed. In examples, when safe box 200 is partially deployed, lid 250 may be protracted only an amount necessary to secure the contents of the safe box. In examples, an internal volume of safe box 200 can be increased or decreased based on the degree of deployment of the safe box 200. In examples, full deployment of safe box 200 will have all components such as lid 250, bottom member 240, and one or more side members 230 fully protracted or extended. In full deployment, the safe box 200 will have a maximum internal volume based on the size lid 250, bottom member 240, and one or more side members 230. In examples, fully collapse of safe box 200 in a stowed state may provide a minimal internal volume. In examples, a fully collapsed safe box 200 may have no internal space to hold an item. In examples, partial deployment of safe box 200 may have an internal volume that is less than its maximum volume in the fully deployed state and greater than the minimum volume in a fully collapsed state.

In examples, varying degrees of deployment of safe box 200 may be correlated to the configuration of lid 250. For example, the amount of protraction adjustments allowed by a lid 250 when engaging front panel 220 may be directly related to the degree of deployment of safe box 200.

In examples, lid 250 may be coupled to the front panel 220. In examples, the varying degrees of deployment of safe box 200 may correspond to the length of panels, sections, or slabs of lid 250. In examples, where panels, sections, or slabs 254 may each have a length of 6 inches the lid 250 may protrude from a portion of door 100 about 6 inches when the safe box 200 is fully collapsed, about 12 inches from a portion of door 100, when the safe box 200 is in a first partially deployed state, about 18 inches from a portion of door 100, when the safe box 200 is in a second partially deployed state, about 24 inches from a portion of door 100 when the safe box 200 is in a third partially deployed state, and about 30 inches from a portion of door 100 when the safe box 200 is fully deployed. In examples, the bottom member 240 of safe box 200 may extend by the same amount as lid 250. Thus, for example, bottom member in its retracted state may not protrude more than about six inches from a portion of door 100, no more than about 12 to 24 inches from a portion of door 100 when the safe box 200 is partially deployed, and no more than about thirty inches from a portion of door 100 when the safe box 200 is fully deployed.

In examples, lid 250 may be configured to couple with at least a portion of front panel 220. In examples, the coupling between lid 250 and front panel 220 may be by way of a lock 258. In examples, lock 258 may be located on a surface of lid 250 and include one or more components configured to engage locking mechanism 227 when engaging front panel 220. In examples, lock 258 on lid 250 is designed to engage with locking mechanism 227 on front portal 220.

In examples, lid 250 may be configured to engage one or more side members 230. Engagement of one or more side members 230 in addition to or in place of front panel 220 may provide improved closure of safe box 200. Any suitable means may be used to engage lid 250 with one or more side members 230. In examples, lid 250 engages one or more side members 230 to prevent access to the internal volume of the safe box 200. In examples, one or more locks 258 and locking mechanisms 227 as described may also be similarly implemented to engage lid 250 with one or more side members 230 in a similar manner as discussed with respect to front portion 220.

As shown in FIG. 8A, a bottom view of lid 250, in examples, lid 250 may include a track, indentation, channel such as a U-channel, spacing, fitting or any like structure 251 configured to engage with at least a portion of one or more side members 230. In examples, lid 250 may include channel or track 251 on a surface of lid 250 that faces at least a portion of one or more side members 230 when the surface of lid 250 is horizontal to a bottom portion of safe box 200. In examples, the channel or track 251 may be wide enough to fit a thickness of one or more side members 230. As illustrated, in examples, the track or channel 251 may extend the length of one or more side members 230. In examples, the lateral width of lid 250 is wider than a space between two or more side members 230. In examples, as illustrated, the track or U-channel 251 may be offset from a side edge of lid 250 and configured to align with a top portion of one or more side members 230. In examples, as lid 250 is extended to a deployed safe box 200, the track or channel 251 is configured to receive a portion one or more side members 230. In examples, the portion of one or more side members 230 received in track or channel 251 may be a thickness of the one or more side members 230.

As shown in FIG. 8A, a bottom view of lid 250, in examples, lid 250 may include a track, indentation, channel such as a U-channel, spacing, fitting or any like structure 253, similar to channel or track 251 as described above, but configured to engage with at least a top edge portion of front panel 220. In examples, lid 250 may include channel or track 253 on a surface of lid 250 that faces at least a portion of front panel 220 when the surface of lid 250 is horizontal to a bottom portion of safe box 200. In examples, the channel or track 253 may be wide enough to fit a thickness of the panel of front panel 220. In examples, as illustrated, channel or track 253 may extend to include round edges so as to accommodate end portions 226a and 226b of front panel 220. In examples, a top edge portion of front panel 220 may refer to a portion extending from the top edge of front panel 220 down to a distance that is greater than 0.01 inches, and less than 0.1 inches, 0.3 inches, 0.5 inches, or 1 inch.

In examples, lid 250 can include one or more locks 258 configured to engage the front panel 220, side member 230, or both. In the example lock 258 may engage with front panel 220. In examples, lock 258 can include a key lock, a smart lock, or a combination thereof. In examples, a lock 258 may include a mechanical fastener configured to couple with a locking mechanism 227 provide on front panel 220, side member 230, or both. In examples, locking mechanisms 227 may include clamps, hooks, J-hooks, loops, rings, screws, hole and pin systems, male-female fittings configured to engage when coupled, gears, magnets, electromagnets, or any combination thereof. In examples, locking mechanism 227 may provide a structure designed to be engaged by at least a portion of lock 258. The lock 258 can include a dial pad, touch screen, scanner, microphone, other input device to allow for input of a code, password, fingerprints, iris scan, voice recognition, or other information by a user, and any combination thereof. As illustrated in FIGS. 6 and 7, which are top down view of door 100 with safe box in stowed and deployed states respectively, lock 258 may include or may be operably connected to a keypad 260, a scanner 261, and a code reader 262, or any combination thereof. In examples, lock 258 may include or be in communication with a memory. A memory may be used to store information necessary for identification. In examples, lock 258 may include or be in communication with a computational unit or a controller. In examples, lock 258 may be operated using a remote device. In examples, remote control can be done via controller 300, directly, or both. In examples, the smart lock can be configured to include or be in communication with a transceiver to enable it to communicate with a remote device. A remote device can be any device capable of wireless communication. In examples, a remote device can be a smart phone, a remote controller, a computer, or any like device. The communication can occur via any wireless means such as for example wi-fi, blue tooth, RF signals, and the like. In examples, the smart lock can be controlled by a controller 300. In examples, the lock 258 can be configured to automatically engage when the lid is closed.

In examples, safe box 200 may include one or more scanners 261. In examples, a scanner 261 may be include a fingerprint scanner, an iris scanner, a voice recognition device, a hand scanner, a facial scanner, or any like device. The scanner 261 can connect to processor or controller 300 that can then initiate one or more operations based on the signal received. In examples, lock 258 may be operatively connected to scanner 261 and/or controller 300. In examples, scanner 261 may be configured to allow for locking and/or unlocking of lock 258.

In examples, the safe box 200 can include a code reader 262 or other like reader that can be used to read an image or symbology on the box, such as a serial number or UPC code, QR code, or other type of image. In examples, the code reader 262 can be a scanner or similar device. In examples, the code reader 262 can be a QR scanner or similar device. The code reader 262 can read the code and then connect to processor or controller 300 that can then initiate one or more operations based on the signal received. In examples, in response to a scan, controller 300 may send a signal confirming receipt and/or identification of the package.

As shown, in examples, the safe box 200 can further include one or more optical sensors 263. In examples, an optical sensor 263 may be a camera. One or more cameras 263 can be located inside the safe box 200, outside the safe box 200, or a combination thereof. In an example, a camera 263 is located outside the safe box 200 to monitor the environment outside the safe box 200. In an example, a camera 263 can be integrated into or installed on the outside of the back panel 204 as shown in FIG. 2. In an example, a camera 263 can be integrated into or installed on top of the lid 250. In an example, a camera 263 is configured to be installed on the surface of the support 200. When installed on the front panel, lid, or support, a camera can be connected by any known means such as adhesive, screws, bolts, or other fastening device. The camera can further be tethered to the safe box 200 by a leash or like structure so that it cannot be safely connected to the safe box 200.

In examples, lid 250 may include one or more optical devices 263. In examples, the optical device 263 can include a camera, charge-couple device (CCD), a CMOS sensor or any like device. In examples, one or more cameras 263 can be infrared cameras. In examples, lid 250 may include a camera facing outside of safe box 200. In examples, lid 250 may include a camera facing inside of safe box 200. In examples, lid 250 may have one or more infrared cameras configured to capture images outside of safe box 200 and one or more infrared cameras configured to capture images inside of safe box 200. In examples, lid 250 may include one or more optical devices or cameras 263 positioned such that when safe box 200 is in a deployed stated, the optical device or camera 263 captures an inside of safe box 200 as shown in FIG. 3 for example, but when safe box 200 is in a collapsed state, the optical device or camera 263 may capture images inside the room or building from which door 100 may block access as for examples illustrated in FIG. 2. As shown, optical device or camera 263 may protrude from lid 250 so that it may capture the area in the room or building when safe box 200 is in a collapsed or stowed state.

In examples, safe box 200 can include one or more sensors 264 to monitor proper closure of the lid or top plate, presence of an object inside the safe box 200, tempering with safe box 200, sense the environment inside safe box 200, or a combination thereof. In examples, the sensors can include thermal sensors, motions sensors, contact sensors, inclination or orientation sensors, lock sensors, or any combination thereof. The one or more sensors 264 can be located in any convenient location inside and/or outside the safe box 200. In examples, a sensor can be configured to detect the presence of an item, package, or parcel inside the box when the item, parcel, or package touches a portion of bottom member 240 of safe box 200. The one or more sensors can send a signal to a controller or processor 300, also included in the safe box 200.

In examples, the safe box 200 can be equipped with a GPS tracker 266. The GPS tracker 266 can be in communication with or be integrated to controller 300. The GPS tracker 266 would preferably be hidden or provided not in a conspicuous manner. In examples, a GPS tracker 266 may also be used to locate a particular safe box 200 for delivery purposes. In examples, the GPS tracker 266 can be used to track the location of door 100 in the event door 100 is misplaced or stolen.

In examples, the safe box 200 can be equipped with an alarm 268 that can be visual, audio or a combination thereof. The alarm 268 can be configured to receive sensor information directly or be controller by controller 300. In examples, the alarm 268 can be configured to signal whether the lid or top panel is not safely locked, whether the package does not properly fit within the safe box 200, whether there is any tempering with the safe box 200 and/or door 100, or any combination thereof. In examples, alarm 268 may be configured to also generate a signal that is sent to a remote device to alert of an event. The signal alert may be sent directly by alarm 268, it may be sent by controller 300 in response of receiving the signal from alarm 268, or both.

In examples, safe box 200 may include a sterilizer 269. In examples, sterilizer 269 may include one or more UV lights. In examples, sterilizer 269 may be controlled by controller 300. In examples, sterilizer 269 may be activated once lid 250 is locked and an item, parcel, or packaged has been detected inside safe box 200. In examples, controller 300 may activate sterilizer 269 for a period of time before causing safe box 200 to retract. In examples, safe box 200 is caused to retract and thus cause the item, parcel, or package therein to transition through opening 180 and into the room or building from which door 100 blocks access after operation of sterilizer 269. In examples, after the item, parcel, or package has been exposed to UV light from sterilizer 269 for a predetermined period of time, safe box 200 can be caused to collapse and thus transition the item, parcel, or package through opening 180. In examples, sterilizer 269 may be controlled manually and/or remotely either directly or by way of controller 300. Direct control of sterilizer 269 may be performed via a control pad provided on lid 150, input in display 130, or via remote communication either directly to sterilizer 269 equipped with a transceiver, or by way of antenna 160.

The overall size of the safe box 200 is not particularly limited. In an example, the internal volume of safe box 200 can be about 30 inches wide, 30 inches deep when fully expanded, and 30 inches tall. The front panel can be oversized to better cover the elements behind it. For example, if distance between the two side members when fully extended is 30 inches, the front panel can be 35 inches wide. In examples, where the safe box is totally expanded opened, the dimensions of its internal volume can be about for a 3 foot door application, i.e. about 36 inches in length, 30 inches in width, and 30 inches in depth. The size can vary slightly on certain measurements and configurations based on different applications. When the secure box is in a collapsed stated, i.e. completely recessed, in a non-use locked position, the depth extruding from the door or any structure adhered to can be about 4 inches to 8 inch. Other sizes can also be implemented. In examples, the size of a deployed safe box 200 may vary depending on whether the safe box 200 is fully or partially expanded.

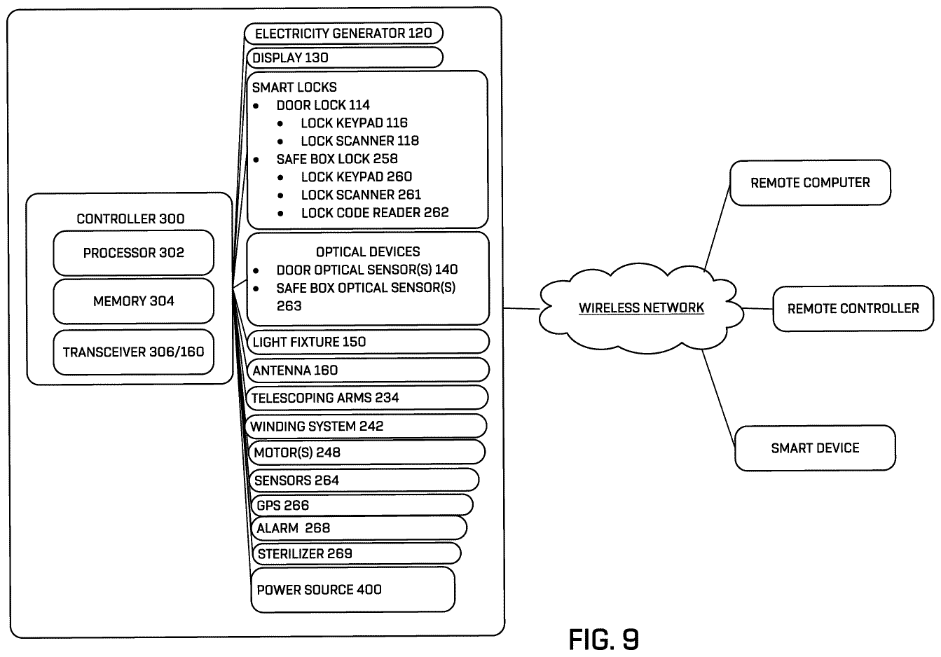

In examples, safe box 200 and/or door 100 may include a controller 300. FIG. 9 illustrates an example of a system that may be employed herein. Controller 300 may include one or more processors 302. In examples, controller 300 can include a transceiver 306 and configured for wireless communication via wi-fi, blue tooth, RF signal or the like. In examples, a transceiver 306 may be part of antenna 160. The controller 300 may include a memory 304. In examples, controller 300 may be configured to control all the electronic elements of the safe box 200 and/or door 100. The controller 300 can be implemented via hardware, software, or combination of both. Controller 300 may be in communication with one or more of the other electronic devices described herein. In examples, all electronic components described herein that are part of safe box 200 and/or door 100 may be controlled by controller 300. In examples, controller 300 may include information and instructions, and/or may be configured to retrieved information and instructions either from memory and/or from a remote source for the operation of all other electronic components. In examples, each electronic component described herein may include or be configured to access, from memory or from a remote source, at least in part instructions and information necessary for its respective operation.

For controller 300, smart lock 114, electricity generator 120, display 130, optical sensors 140, antenna 160, motor 248, lock 258, scanner 261, code reader 262, optical sensors 263, sensors 264, battery 400 and for any other electronic component described herein, the functions described herein may be stored as one or more instructions or code on a non-transitory computer-readable or processor-readable storage medium. The steps of a method or algorithm disclosed herein may be embodied in a processor-executable software module, which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used herein, include compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

In examples, the controller 300 can be controlled remotely. In examples, the controller 300 can be configured to follow preset operations or receive input for operation based on signals sent from the camera, sensors, lock, or any combination thereof.

In examples, the controller 300 can be configured to operate in conjunction with a software application. The application can be downloaded on a user device to allow control and communication with controller 300. The application can be configured to receive alerts. The application can be configured to lock and unlock smart lock 114 and/or 258. The application can be configured to stream video feed from the one or more optical sensors 140 and/or 263. The application can be used to select a display such an image, message, or any combination thereof on display 160. The application can be used to control, set off, and/or shut off an alarm. Other features can also be implemented.

In examples, all electronic devices described herein may be controlled via controller 300, may operate independently, or both. Controller 300 may be in communication with any one of the one or more electronic devices via a wire connection, wireless connection, or both. In examples, communication between devices can be achieved using one or more transceivers or like device. In examples, as illustrated in FIG. 9 a controller 300 includes one or more processors 302, one or more memory 304, and one or more transceivers or like device 306. Information, logic and software applications for the control of one or more electronic devices may be stored in one or more memory 304. In examples, remote control of any of these electronic devices may be accomplished by remote control, by a remote computer or computing device, a smart device such as a smart phone or any combination thereof. Remote control can be accomplished via a wireless network as described. Communication form a remote device can be transmitted to controller 300 to then control one or more electronic devices. In examples, one or more of the electronic devices may be configured to operate independently in addition to and/or instead of receiving control signals by controller 300. In examples, one or more of the electronic devices may include similar components to the controller 300 as described herein. For example, one or more of the electronic devices may include any one or more processors, memory with stored logic and/or software for operation, and transceivers or like device for wireless or wired communication. In examples, the controller 300 and one or more electronic devices may share components such as processors, memory, and/or transceiver or like device.

In examples, the controller 300 can be configured to send a notification to the user when a package or parcel is detected inside the safe box. The notification can be delivered electronically. If an app is used, the notification can be sent via the software application.

Powering the electrical components described above, door 100 can include a power source 400. In an example, the power source 400 can be a battery, a gel pack, a capacitor or like device. In examples, the power source 400 may be removable. In an example, the power source 400 can be a rechargeable battery. In examples, the power source 400 may be removed from door 100, charged, and then reinstalled. In examples, the power source 400 can be located in back frame 204. In examples, power source 400 may be connected to a portion of back frame 204 that is proximate to the location of motor 248. The power source can include a wired connection to an electrical source such as an AC or DC power source that may be on the fixture or surrounding area. In examples, power source 400 can include a connection to a power voltage of 120 v/220 v or the like. In examples, power source 400 may be operably connected to one or more electricity generators 120 to recharge the power source 400 and/or to power any of the components in door 100 and safe box 200.

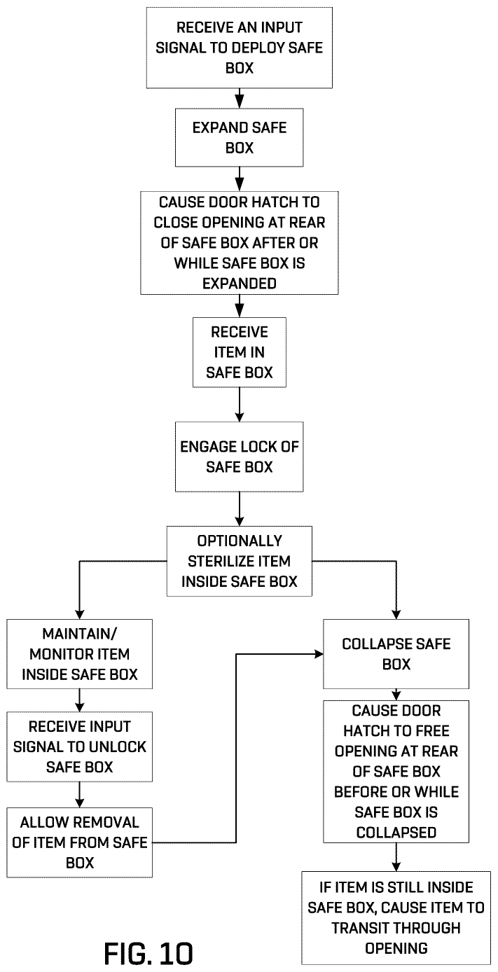

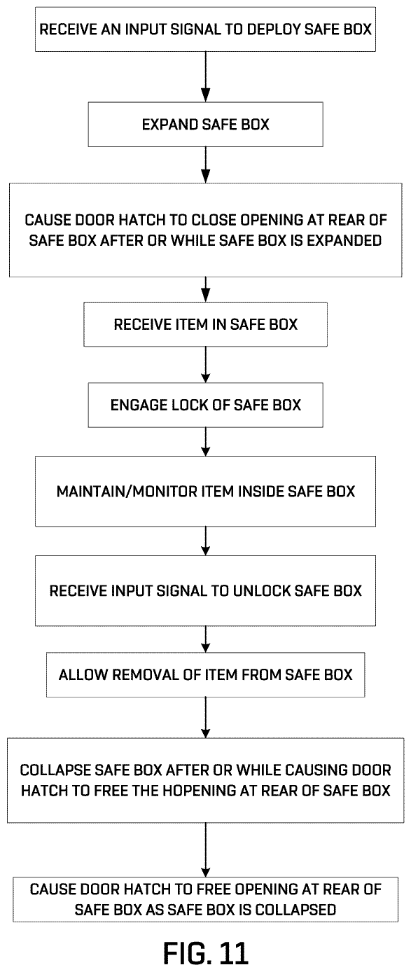

In examples, door 100 can be used for the delivery of an item or package. FIGS. 10 and 11 provide example process flows of the system of door 100. FIG. 10 illustrates an example process flow of door 100 to receive delivery of an item, package, or parcel as described herein. FIG. 11 illustrates an example process flow of door 100 to store an item, package, or parcel for pickup and delivery as described herein.

The safe box 200 may be kept in its collapsed state when not in use. In this state the one or more side members, lid, and bottom member are in a retracted and/or stowed state until it is required to deposit an item, parcel, or package. Safe box 200 may be used to receive delivery and for delivery pick-up. In this manner the safe box takes little space. Door 100 can have a built-in active screen such as an LED screen. The screen can be used to display information. For example, the screen can be used to display the address. This may assist the delivery company find the user's address at night. The screen can also provide other information that a user may want to communicate.

When a packaged is delivered, safe box 200 can be actuated by a touch button release or other means. The deployed state can be a fully extended safe box, or a partially extended safe box. In examples, the safe box can be configured to expand on its own once activated without requiring it to be manually opened. As this occurs the one or more side members, bottom member and lid of the safe box protract partially or fully. An item or package can then be placed inside the safe box. The lid can then be closed and locked by engaging the lid with the front panel and/or one or more side members. In this manner the item or package can remain safely secured inside the safe box. In examples, where the item or package is placed in safe box 200 for pick-up, the item or package can be securely stored in safe box 200 until it is picked up for delivery. Access to safe box 200 may then be gained via smart lock 114 and/or by remote communication via antenna 160. In examples, where the item or package is placed in safe box 200 by a delivery, i.e. the item or package is being delivered to door 100 as its final destination, safe box 200 can be closed and/or can automatically close upon placement of the parcel or package inside, optionally conduct a sterilization process for example by exposing the item or package to UV light, and then return to its collapsed state thereby transitioning the item or package through opening 180 and into the room or building from which door 100 blocks access when closed.

In examples, safe box 200 may be employed to receive a delivery or for pick-up of an item being delivered. In examples, where safe box 200 is used to receive a delivery, control system of controller 300 as described of the door 100 may receive an input signal to deploy a safe box. The input signal may be received wirelessly, via touch screen on one or more displays 130, or by operation of safe box lock 258. In response to the signal, controller 300 may cause expansion of the safe box. Controller 300 may also cause door hatch 190 to block of opening 180 that extends from a front side of the door to a back side of the door and is located at a rear portion of the safe box. In examples, controller 300 may cause door hatch 190 to block opening 180 either after the safe box is fully deployed or while the safe box is being deployed. An item may then be received in the safe box. The safe box may then be locked. In examples, the safe box 200 may remain in the locked position and safely hold the received item, package, or parcel. In such case, a user may then access the safe box by unlocking and opening lid 250. Alternatively, the safe box may be caused to retract either after or while causing door hatch 190 to unblock opening 180. As the safe box collapses, it may cause the item, package, or parcel contained therein to pass through the opening 180. In examples, the item, package, or parcel may then travel down ramp 270 as it reaches the inside of the room or building to which door 100 blocks access when closed.

In examples, where safe box 200 is used to hold an item, package, or parcel for pickup and delivery, a user may activate and cause safe box 200 to expand by sending an input signal either manually using display 130 as input device, by operating safe box lock 258, or by sending an input signal wirelessly to control system of controller 300. In response to the input signal, controller 300 may cause expansion of the safe box. Controller 300 may also cause door hatch 190 to block of opening 180 that extends from a front side of the door to a back side of the door and is located at a rear portion of the safe box. In examples, door hatch 190 may be caused to block opening 180 either after safe box is fully expanded or while safe box is expanding. An item may then be placed in the safe box 200. The safe box 200 may then be locked. In examples, the safe box 200 may remain in the locked position and safely hold the item, package, or parcel until it is picked up. At time of pickup, the party picking up the item may access the safe box by unlocking and opening lid 250. After the safe box 200 has been emptied, controller 300 may cause the safe box 200 to return to its stowed or collapsed state after or while also causing door hatch 190 to unblock opening 180.

In examples, a camera can be used to monitor any activity surrounding the safe box. This can provide any information about delivery, or any attempt tempering with the safe box.

One or more sensors can detect the proper closure of the safe box. The sensors can signal to a processor that can then either engage the alarm system, sterilizer, stay in stand-by secure mode, or a combination thereof.

In examples, the safe box can also be used to ship items or packages. In such a scenario, the user can place an item or package in the secure box and inform the delivery company that the item or package is ready for pick up. The delivery person can then access the package by unlocking the safe box for example by using a code provided to them by the user.

After delivery or pickup, the safe box can be retracted and collapsed back into place. The safe box may be configured to retract automatically or may retract by pushing the front panel toward the back panel until the fasteners lock the two in place. In this manner, the safe box does not occupy unnecessary space.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

1-41. (canceled)

42. A door assembly comprising:
a collapsible safe box movable between a collapsed configuration and a deployed configuration, the collapsible safe box including:
at least one protractible and retractable side member,
a protractible and retractable lid,
a protractible and retractable bottom member,
a roller configured to wind and unwind the protractible and retractable bottom member, and
a reel or cog operably connected to the roller;
an opening aligned with an internal portion of the safe box; and
a door hatch operably connected to the reel or cog and configured to close the opening when the safe box is in the deployed configuration,
wherein the reel or cog is configured to cause the door hatch to move between an open position and a closed position in response to movement of the safe box between the collapsed configuration and the deployed configuration.

43. The door assembly of claim 42, the collapsible safe box further comprising at least two protractible and retractable side members.

44. The door assembly of claim 43, the collapsible safe box further comprising a telescoping arm operably connected to at least one of the at least two protractible and retractable side members.

45. The door assembly of claim 42, the collapsible safe box further comprising a front panel, wherein the protractible and retractable lid is configured to engage the front panel.

46. The door assembly of claim 42, wherein the protractible and retractable lid comprises two or more stackable panels.

47. The door assembly of claim 42, the collapsible safe box further comprising a lid housing configured to store at least a portion of the protractible and retractable lid in a stowed state.

48. The door assembly of claim 47, the door further comprising:
a front side and an opposite back side,
wherein:
the lid housing is on a back side of the door; and
at least a portion of the protractible and retractable lid is on a front side of the door when protracted.

49. The door assembly of claim 42, the collapsible safe box further comprising:
a back frame located on a back side of the door; and
a ramp pivotally connected to the back frame.

50. The door assembly of claim 42, wherein the reel or cog is operably connected to the door hatch via one or more cables.

51. The door of claim 42, further comprising a motor operably connected to the roller, wherein the reel or cog is operably connected to the motor.

52. A collapsible safe box movable between a collapsed configuration and a deployed configuration, comprising:
at least one protractible and retractable side member;
a protractible and retractable lid;
a protractible and retractable bottom member;
a roller configured to wind and unwind the protractible and retractable bottom member; and
a reel or cog operably connected to the roller and comprising an engagement interface configured to mechanically couple with an access panel,
wherein the reel or cog is configured to cause the access panel to move between an open position and a closed position in response to movement of the safe box between the collapsed configuration and the deployed configuration.

53. The collapsible safe box of claim 52, wherein the engagement interface comprises one or more of: a gear tooth, a cable attachment point, a linkage connection.

54. The collapsible safe box of claim 52, further comprising a housing, wherein the at least one protractible and retractable side member, the protractible and retractable lid, and the protractible and retractable bottom member are each movably connected to the housing.

55. The collapsible safe box of claim 52, wherein the reel or cog is mechanically linked to the roller such that rotation of the reel or cog in a first direction causes the roller to unwind the protractible and retractable bottom member and rotation of the reel or cog in a second direction causes the roller to wind the protractible and retractable bottom member.

56. The collapsible safe box of claim 52, wherein the at least one protractible and retractable side member comprises a plurality of protractible and retractable side members.

57. A method of operating a door assembly having a collapsible safe box, comprising:
providing a door comprising:
a collapsible safe box movable between a collapsed configuration and a deployed configuration, the collapsible safe box including:
at least one protractible and retractable side member,
a protractible and retractable lid,
a protractible and retractable bottom member,
a roller configured to wind and unwind the protractible and retractable bottom member, and
a reel or cog operably connected to the roller,
an opening aligned with an internal portion of the safe box, and
a door hatch operably connected to the reel or cog;
moving the collapsible safe box from the collapsed configuration to the deployed configuration, thereby causing:
the roller to unwind the protractible and retractable bottom member,
the at least one protractible and retractable side member to extend,
the protractible and retractable lid to extend, and
the reel or cog to move the door hatch from an open position to a closed position to close the opening.

58. The method of claim 57, further comprising:
moving the collapsible safe box from the deployed configuration to the collapsed configuration, thereby causing:
the roller to wind the protractible and retractable bottom member,
the at least one protractible and retractable side member to retract,
the protractible and retractable lid to retract, and
the reel or cog to move the door hatch from the closed position to the open position to open the opening.

59. The method of claim 57, wherein providing the door comprises manufacturing the door by integrating the collapsible safe box with the door hatch and the opening.

60. The method of claim 57, wherein moving the collapsible safe box from the collapsed configuration to the deployed configuration comprises pulling the collapsible safe box away from the door.

61. A method of deploying a collapsible safe box, comprising:
providing a collapsible safe box comprising:
at least one protractible and retractable side member,
a protractible and retractable lid,
a protractible and retractable bottom member,
a roller configured to wind and unwind the protractible and retractable bottom member, and
a reel or cog operably connected to the roller and comprising an engagement interface configured to mechanically couple with an access panel;
coupling the engagement interface of the reel or cog to the access panel; and
moving the collapsible safe box from a collapsed configuration to a deployed configuration, thereby causing the roller to unwind the protractible and retractable bottom member and causing the reel or cog to move the access panel from an open position to a closed position.
